(19) United States
(12) Patent Application Publication
(10) Pub. No.: US 2015/0087324 A1
(43) Pub. Date: Mar. 26, 2015

(54) BASE STATION, WIRELESS COMMUNICATION SYSTEM, AND WIRELESS COMMUNICATION METHOD

(71) Applicant: HITACHI, LTD., Tokyo (JP)

(72) Inventors: Hitoshi ISHIDA, Tokyo (JP); Tomonori YAMAMOTO, Tokyo (JP); Satoshi TAMAKI, Tokyo (JP); Rintaro KATAYAMA, Tokyo (JP); Eriko TAKEDA, Tokyo (JP); Tsuyoshi TAMAKI, Tokyo (JP)

(21) Appl. No.: 14/473,495

(22) Filed: Aug. 29, 2014

(30) Foreign Application Priority Data
Sep. 20, 2013 (JP) 2013-194816

(51) Int. Cl. H04L 5/00; H04W 52/24; H04W 72/04

(52) U.S. Cl. CPC H04L 5/0035; H04W 72/0426; H04W 52/244; H04W 72/0453
USPC 455/452.2

(57) ABSTRACT

A base station is provided with a plurality of radio units that communicate with a terminal, and a control device connected to the plurality of radio units. When there is a large number of terminals positioned at a boundary of the communication areas of a first radio unit and a second radio unit among the plurality of radio units, the control device makes a first cell ID of the first radio unit and a second cell ID of the second radio unit being identical.

### CROSS-REFERENCE TO RELATED APPLICATIONS

This application claims the priority of Japanese Patent Application No. 2013-194816, filed on Sep. 20, 2013, which is incorporated herein by reference in its entirety.

### BACKGROUND OF THE INVENTION

1. Field of the Invention

The present invention relates to a wireless communication system.

2. Description of the Related Art

As a result of the widespread use of smartphones, tablet terminals and the like, there is a concern for an explosive increase in wireless traffic. In order to accommodate such increasing wireless traffic, the capacity for wireless traffic (wireless communication capacity) needs to be increased. As a technology for increasing the wireless communication capacity, a small cell configuration is gaining attention in which a service area is covered by a number of low transmission power base stations with narrow communication areas. In the long term evolution (LTE) standard, which is a next-generation wireless communication standard, the base station may be referred to as an E-UTRAN NodeB (eNB), and a terminal as user equipment (UE).

The small cell is referred to as a microcell, a picocell, or a femtocell, for example. The base station covering the small cell is referred to as a micro base station (micro eNB), a pico base station (pico eNB), or a femto base station (femto eNB), for example. The femto base station may also be referred to as a Home eNB (HeNB). Meanwhile, a base station with high transmission power and a wide communication area is referred to as a macro base station (macro eNB), and the communication area of the macro base station is referred to as a macrocell.

Generally, the wireless communication capacity can be increased by making the cell smaller and providing a number of such small cells. When the cell is made smaller, the distance between terminals and the base station is decreased. As a result, attenuation of radio waves may be reduced, resulting in improved communication quality.

### SUMMARY OF THE INVENTION

On the other hand, when a number of small cells are disposed at high density, communication quality may be significantly decreased by radio wave interference between different cells at the boundary of the communication areas of the cells (referred to as a “cell boundary”). Particularly, in the small cell, because the area of one cell is narrow compared with the macrocell, it is believed difficult to adopt, prior to the installation of the base station, a cell design such that an area in which terminals are less likely to be distributed is located at the cell boundary. Thus, it can be expected that the distribution of the terminals in the cell will be greatly varied depending on the time. For example, in a certain cell at a certain time, a number of terminals may be distributed near the cell boundary. As a result, communication quality may be lowered by inter-cell interference. Further, handovers for switching the cells to which the terminals connect will be frequently generated, increasing the process delay due to transmission and reception of control signals, synchronization with a new cell and the like, and lowering communication efficiency.

As a technology for decreasing inter-cell interference, fractional frequency reuse (FFR) is known. According to the FFR technology, the transmission power of the base station is varied on a frequency by frequency basis and controlled such that frequencies with high transmission power are not overlapped between base stations, thus decreasing interference. FFR is discussed in JP-2012-500524-W, for example.

As another technology for decreasing inter-cell interference, coordinated multi point operation (CoMP) is known, which is a technology for coordinated transmission and reception between base stations.

According to FFR or CoMP, the inter-cell interference can be decreased. However, handovers do occur due to movements between cells. Thus, the technologies cannot solve the problem of the decrease in communication efficiency due to the occurrence of frequent handovers. Further, in order to perform CoMP, the terminals need to be adapted for the signal transmission and reception with a plurality of cells, which may increase the complexity of the terminals for supporting this function. Thus, whether CoMP can be applied depends on the support function of the terminals, and CoMP may not be applicable to all of the terminals.

As a technology for achieving a decrease in handovers in a small cell, dual connectivity is being considered. Dual connectivity is contemplated for application in a network configuration in which a number of small cells are disposed in a macrocell in an overlapping manner. Such network configuration may be referred to as a heterogeneous network (HetNet). The macrocell and the small cells use different frequency carriers. In dual connectivity, the macrocell ensures coverage, while the small cells are responsible for increasing wireless capacity. The terminals perform communications using both the macrocell and the small cells. When a terminal moves into a different small cell, the small cells are switched while connection with the macrocell is maintained. Thus, even when the small cell is modified, handover can be decreased because the connection with the macrocell is maintained.

However, in the case of dual connectivity, the terminals also need to support the function for communication with a plurality of cells, and dual connectivity may not be applicable to all of the terminals, as in the case of CoMP. There is also the possibility that dual connectivity cannot be applied due to the absence of a macrocell coverage at the location of a small cell.

The present invention was made in view of the above, and is directed to enabling an improvement in communication quality and a decrease in handover in a wireless communication system. Particularly, the present invention is directed to a wireless communication system including a number of small cells, where communication quality is increased by a decrease in inter-cell interference and a decrease in handover even when a number of terminals are distributed near a cell boundary, or when a terminal that does not support CoMP or dual connectivity is present.

The outline of a representative aspect of the present invention disclosed herein is as follows.

A base station includes a plurality of radio units that communicate with a terminal; and a control device connected to the plurality of radio units. When there are a large number of terminals positioned at a boundary of communication areas of a first radio unit and a second radio unit among the plurality of radio units, the control device makes a first cell ID of the first radio unit and a second cell ID of the second radio unit being identical.

According to the present invention, communication quality can be increased and handover can be decreased in a wireless communication system. Particularly, in a wireless communication system including a number of small cells, when a number of terminals are distributed near a cell boundary, or when there is a terminal that does not support CoMP or dual connectivity, an increase in communication quality and a decrease in handover can be achieved by a decrease in inter-cell interference.

Other objects, configurations and effects of the invention will become apparent from the following description of embodiments.

### BRIEF DESCRIPTION OF THE DRAWINGS

FIG. 1 illustrates an example of a system configuration of the present invention;

FIG. 2 is a conceptual diagram of a first embodiment of the present invention;

FIG. 3 illustrates an example of a CSI-RS setting method;

FIG. 4 illustrates an example of a device configuration according to the first embodiment of the present invention;

FIG. 5 illustrates an example of a downlink configuration of a switch;

FIG. 6 illustrates an example of an uplink configuration of the switch;

FIG. 7 illustrates an example of an operation sequence for allocating an identical cell ID to a plurality of RUs in the first embodiment of the present invention;

FIG. 8 illustrates the correspondence between RU, cell ID, and L2/L3 processor;

FIGS. 9A and 9B illustrate examples of the number of terminals positioned at the center and boundary of the communication area of RU;

FIG. 10 illustrates an example of changes in communication area when cell ID is modified;

FIG. 11 illustrates an example of an operation sequence for cell ID allocation;

FIG. 12 illustrates an example of an operation sequence in a case where an identical cell ID is allocated to a plurality of RUs in the first embodiment of the present invention;

FIG. 13 is a first conceptual diagram of a second embodiment of the present invention;

FIG. 14 is a second conceptual diagram of the second embodiment of the present invention;

FIG. 15 is a third conceptual diagram of the second embodiment of the present invention;

FIG. 16 illustrates an example of a device configuration according to the second embodiment of the present invention;

FIG. 17 illustrates an example of an operation sequence up to the allocation of an identical cell ID to a plurality of RUs according to the second embodiment of the present invention;

FIG. 18 illustrates a first example of an operation sequence in a case where an identical cell ID is allocated to a plurality of RUs according to the second embodiment of the present invention;

FIG. 19 illustrates a second example of the operation sequence in the case where an identical cell ID is allocated a plurality of RUs according to the second embodiment of the present invention; and

FIG. 20 illustrates an example of the device configuration according to a third embodiment of the present invention.

### DESCRIPTION OF THE PREFERRED EMBODIMENTS

In the following, embodiments of the present invention will be described with reference to the drawings.

While the following description of embodiments may be divided into a plurality of sections or embodiments as needed for convenience, they are not mutually unrelated unless specifically noted otherwise, and are in a relationship such that one may be a part of the other or a modification, a detail, a supplementary description or the like of the whole, for example. The embodiments may be implemented individually or in combination.

Further, in the following embodiments, when references are made to the number of elements and the like (including the number of items, numerical values, amounts, and ranges), the embodiments are not limited to the specific numbers, and more or less than the specific number may be used unless specifically noted otherwise, or unless the embodiments are obviously limited to the specific number in principle.

It should be obvious that in the following embodiments, the constituent elements and the like (including element steps and the like) may not necessarily be required unless specifically noted otherwise or unless obviously considered indispensable in principle.

Similarly, in the following embodiments, when references. are made to the shape of constituent elements, their positional relationship and the like, the shape and the like may include substantially approximate or similar shapes unless specifically noted otherwise or unless the shapes are obviously not the case in principle. This also applies to the numerical values or ranges.

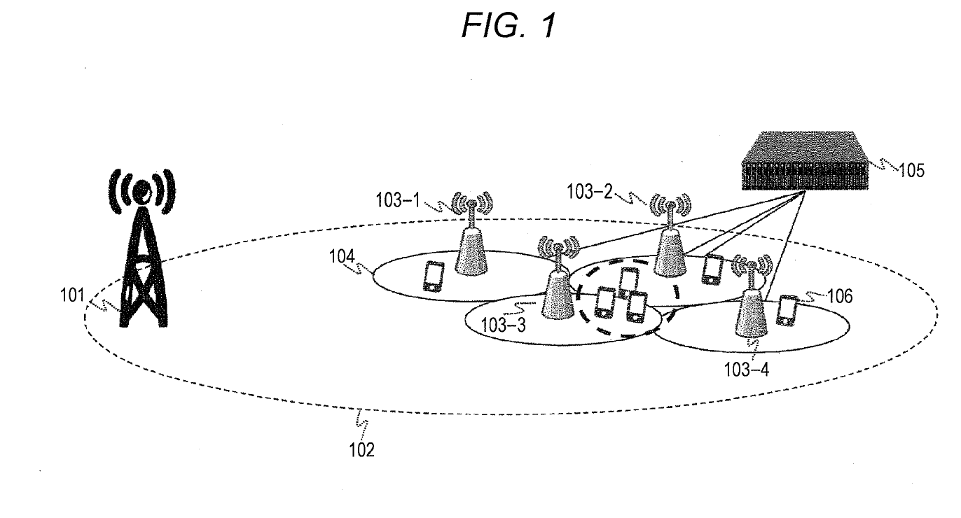

FIG. 1 illustrates an example of a wireless communication system to which the present invention is directed. A macro base station 101 forms a macrocell 102, and small cell base stations 103-1 to 103-4 form small cells 104. The small cell base stations 103-1 to 103-4 are connected to a control device 105. The control device 105 and the small cell base stations 103-1 to 103-4 may be connected via wired or wireless lines. In the following, unless distinctions are specifically required, the small cell base stations 103-1 to 103-4 will be simply referred to as a small cell base station 103. The same applies to the others. While in the example of FIG. 1, the small cells 104 are overlapping the macrocell 102, the area of the macrocell 102 may not be present. In some cases, the small cells 104 may be positioned near the boundary of the areas of a plurality of macrocells 102. While in the following, the present invention will be described with reference to the small cells 104 and the small cell base stations 103 by way of example, the present invention is not limited to the small cells 104 or the small cell base stations 103 and may be applied to the macrocell 102 or the macro base station 101.

Referring to FIG. 1, the small cell base stations 103 may include a remote radio head (RRH) with only a wireless function or with only some of base station functionality. Similarly, the control device 105 may be only provided with a control function, some of the base station functionality, or all of the base station functionality except for the wireless function.

Without loss of generality in description, in the following, the small cell base stations 103 will be denoted as a remote unit (RU) 103, and the control device 105 will be denoted as a center unit (CU) 105. The system including RU 103 and CU 105 may be referred to as a cloud-radio access network or centralized-RAN (C-RAN) system, or a C-RAN base station.

In such a small cell environment, a large number of terminals may be distributed near the cell boundary, such as of the small cells 104 formed by RUs 103-2 and 103-3 in FIG. 1, at a certain location or at a certain time. As a result, the signals transmitted from the respective RUs 103 may interfere with each other, causing a decrease in communication quality. Further, frequent handovers may occur between the small cells formed by RU 103-3 and RU 103-2, decreasing the communication efficiency.

The present invention provides a wireless communication system, a base station, and a base station control method by which the above problems can be solved.

### 1. First Embodiment

In a first embodiment, it is contemplated that each RU 103 uses a single frequency carrier.

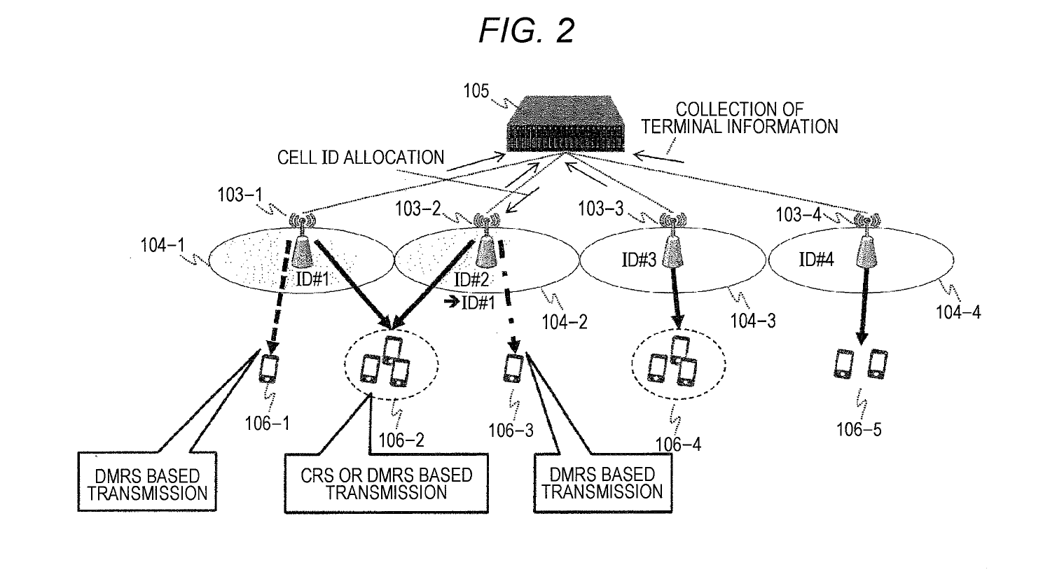

FIG. 2 is a conceptual diagram of the first embodiment of the present invention. RU 103-1 to RU 103-4 form different small cells 104-1 to 104-4, respectively. RU 103-1 to 103-4 transmit signals using respectively different cell IDs (#1 to #4). The cell ID is an identifier for distinguishing the signal of each cell, and is referred to as a physical layer cell identity (PCI) according to LTE, for example. A terminal (or a group of terminals) 106-2 is positioned near the boundary of the communication areas of RUs 103-1 and 103-2, where the communication quality is decreased by inter-cell interference. There is also the possibility of repeated handovers occurring between the cells 104-1 and 104-2.

CU 105 collects terminal distribution information on the basis of information reported from the terminals 106 communicating with each RU 103, and detects the area in which a number of terminals are distributed near the cell boundary, and RU 103 covering the area. In the example of FIG. 2, a number of terminals 106-2 are distributed at the boundary of the communication areas of RU 103-1 and RU 103-2. CU 105 allocates an identical cell ID to the plurality of RUs 103 covering the area. In the example of FIG. 2, the cell ID of RU 103-2 is modified from #2 to #1, thus providing RUs 103-1 and 103-2 with an identical cell ID. As described above, the synchronization signal, a unique reference signal of each cell (Cell Specific Reference Signal: CRS) and the like become identical for RUs 103-1 and 103-2. As a result, the communication areas 104-1 and 104-2 of RUs 103-1 and 103-2 equivalently constitute a single larger cell. Accordingly, handover ceases to occur at the boundary of the communication areas of RUs 103-1 and 103-2. Further, because the area in which the terminal group 106-2 is positioned ceases to be a cell boundary, the problem of a decrease in communication quality in the area can be solved. Specifically, when a signal is transmitted to a terminal positioned near the boundary of the communication area of RU 103, the same signal is transmitted from the plurality of RUs 103. As a result, the effect of soft combining can be obtained, thus enabling an increase in communication quality as by CoMP. The signals transmitted from the plurality of RUs 103 with the identical cell ID allocated thereto are, to the terminal 106, equivalent to a multipath with different channels. Thus, in order to receive the signals transmitted from the plurality of RUs 103 to which the identical cell ID is allocated, the function for receiving signals from a plurality of cell, as in CoMP, is unnecessary.

Thus, CU 105 detects that a large number of terminals are distributed near the boundary of the communication areas of certain RUs 103, and allocates an identical cell ID to a plurality of RUs 103 covering the area. In this way, the communication quality of an area having the problem of a decrease in communication quality due to inter-cell interference or frequent handovers can be increased, and handovers can be decreased.

However, when a plurality of RUs 103 are given with an identical cell ID, if signals are transmitted to all of the terminals 106 using the multiple RUs 103 to which the terminals are connected, the number of terminals that can communicate simultaneously, i.e., the amount of wireless resources available per terminal, may be decreased, resulting in a decrease in throughput compared with when different cell IDs are allocated. For example, because the influence of inter-cell interference is small on the terminals 106 positioned at the center of the communication area of RU 103 (such as terminals 106-1 and 106-3 in FIG. 2), the effect of communication quality improvement obtained by transmitting signals using a plurality of RUs 103 (RU 103-1 and RU 103-2 in FIG. 2) is believed to be small. Thus, by transmitting data to such terminals 106 using a single RU 103, the number of simultaneously communicating terminals, or the amount of wireless resources available per terminal may be increased, whereby throughput may be increased.

A method of solving the above problem will be described below. The LTE standard includes a transmission mode using the above-described CRS as a reference signal (referred to as Transmission Mode), and a transmission mode using a reference signal for demodulation (referred to as demodulation RS (DMRS) or UE specific RS). CRS includes a sequence unique to the cell ID, and cannot be transmitted from only some of the plurality of RUs 103 having an identical cell ID. This is because CRS is used not only for demodulation of data but also for reception power measurement, control channel demodulation, and demodulation of broadcast signal or paging, and is therefore received by terminals other than the data receiving terminal. Namely, it may be said that the size of the cell is determined by the area in which CRS can be received. Thus, for CRS, the same signal is transmitted from a plurality of RUs 103 having the identical cell ID. Accordingly, if data is transmitted only from a single RU 103, the channel of the data and the channel estimated from CRS would not correspond to each other, thus lowering reception performance.

On the other hand, DMRS is a dedicated reference signal for data demodulation, and may be transmitted from only some of the plurality of RUs 103 having an identical cell ID. Thus, to the terminals 106 positioned at the center of the communication area of RU 103, such as terminals 106-1 and 106-3 in FIG. 2, signals can be transmitted from the single RU 103 using the same wireless resources. However, when the cell ID is different, rules for mapping to the data resource and the like are different. Thus, the transmitting RU 103 needs to be RU 103 that uses the identical cell ID to the cell to which the terminal 106 connects. Also, DMRSs transmitted from different RUs 103 need to be different in logical antenna port number or the DMRS signal sequence. For example, in transmission mode 7 (TM7) in LTE, logical antenna port 5 is used, and the signal sequence of DMRS is dependent on an identifier of the terminal 106 referred to as radio network temporary identifier (RNTI). Generally, different RNTIs are allocated to the terminals 106 connecting to the same cell, so that TM7 satisfies the above condition. Meanwhile, in TM8 or TM9, antenna ports 7-14 are used, and the signal sequence of DMRS is determined by the cell ID and the signal sequence of DMRS called an SCID, or by parameters for determining a scramble sequence. SCID takes the value of 0 or 1. The SCID and the antenna port number used are notified from the base station to the terminals by physical downlink control channel (PDCCH) for scheduling information notification. Thus, when TM8 or 9 is used, it is necessary to use different antenna ports or different SCIDs between terminals to which signals are transmitted from different RUs 103 having the identical cell ID. Further, in TM 10, in addition to the antenna port and SCID, a virtual cell ID may be set in the terminal. The virtual cell ID is a parameter for determining the scramble sequence of DMRS, as in SCID. Thus, in TM 10, the antenna port, SCID, or the virtual cell ID is varied between the terminals.

Based on the foregoing, the operation in the case where an identical cell ID is allocated to a plurality of RUs 103 is as follows.

In the terminals 106 positioned at the center of the communication area of RUs 103 to which an identical cell ID is allocated, a transmission mode using DMRS (such as TM7, 8, 9, or 10) is set, and signals are transmitted using a single RU 103.

In the terminals 106 positioned near the boundary of the communication areas of RUs 103 to which an identical cell ID is allocated, a transmission mode using CRS or a transmission mode using DMRS is set, and signals are transmitted using a plurality of RUs 103. When signals of different terminals 106 are transmitted from different RUs 103 having an identical cell ID, different DMRS antenna port numbers or signal sequences (scramble sequences) are used.

The transmission using a plurality of RUs 103 and the transmission using a single RU 103 may be handled as an example of multi-user multiple input multiple output (MIMO) or beamforming, rather than the CoMP function. In multi-user MIMO, simultaneous communications with a plurality of terminals are performed using a plurality of antennas and the same wireless resources. On the other hand, in single user MIMO, communication with a single terminal is performed using a plurality of antennas. Multi-user MIMO is a MIMO precoding control method for preventing mutual interference between signals from simultaneously communicating terminals by the use of a directional beam. Meanwhile, the method where communications with different terminals are performed using one of the plurality of RUs 103 having an identical cell ID may be considered to be a multi-user MIMO in that simultaneous communications are performed with a plurality of terminals using different RUs 103 such that mutual interference can be decreased by radio wave attenuation. Also, in the present embodiment, the method of communicating with a single terminal using a plurality of RUs 103 may be considered to be a single user MIMO.

The terminals 106 also measure the communication quality and channel information of the connected cell, and feedback a measurement result to the base station. The feedback information is referred to as channel state information (CSI). The CSI includes, for example, a channel quality indicator (CQI) indicating communication quality, a precoding matrix indicator (PMI) indicating MIMO precoding information, and a rank indicator (RI) indicating the number of layers that can be transmitted by MIMO. In the transmission mode using DMRS, CSI measurement is performed using CRS, CSI-RS or the like. When CSI is measured using CRS, the measured CSI is a combination of CRS' transmitted from a plurality of RUs 103. The signals between RUs 103 having the identical cell ID are not included in interference. Namely, the CSI fed back by the terminal 106 is the CSI in the case of transmission using a plurality of RUs 103 having the identical cell ID. Thus, the CSI in the case of signal transmission using a single RU 103 may differ from the information fed back by the terminal 106. Accordingly, it is necessary to correct or estimate in CU 105 the CSI in the case of the signal transmission from the single RU 103. For example, a method may be contemplated where CU 105 estimates the uplink channel on the basis of an uplink reference signal, and uses that information for downlink CSI. This will be particularly effective in a time division duplex (TDD) system. Alternatively, outer loop link adaptation (OLLA) that corrects CQI in accordance with the ACK information of data may be used. In this case, OLLA may be applied independently (distinguishing the number of times of ACK) between when a plurality of RUs 103 are used and when a single RU 103 is used. Alternatively, OLLA may be applied only when a single RU 103 is used.

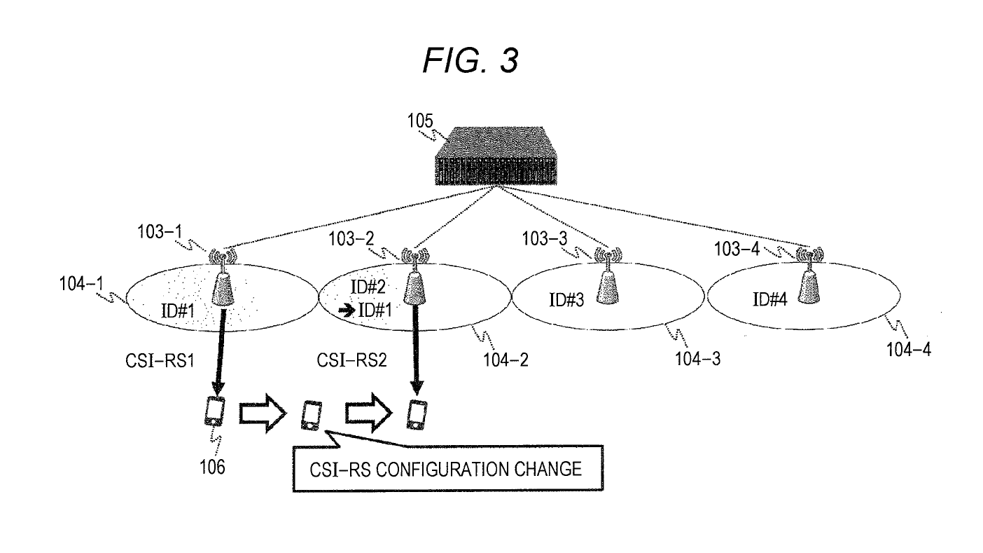

When the CSI is measured using CSI-RS, the same CSI-RS may be transmitted from a plurality of RUs 103 having an identical cell ID, as in the case of CRS. In this case, correction of the CSI may be performed by the same method as for CRS. Alternatively, different CSI-RS may be transmitted from each RU 103, as in FIG. 3. The “different CSI-RS” means that the signal is different in any of the timing of transmission of CSI-RS, the time and frequency resource, and the sequence of CSI-RS. In FIG. 3, RUs 103-1 and 103-2 transmit different CSI-RS (CSI-RS1 and CSI-RS2). CU 105 detects whether the terminal 106 is positioned in the communication area of RU 103-1 or 103-2. When the area in which the terminal is positioned is changed, the corresponding CSI-RS may be reset. Alternatively, a separate CSI-RS (such as CSI-RS3) may be transmitted from both RUs 103-1 and 103-2, and CSI-RS3 may be set when the terminal 106 is positioned near the area boundary.

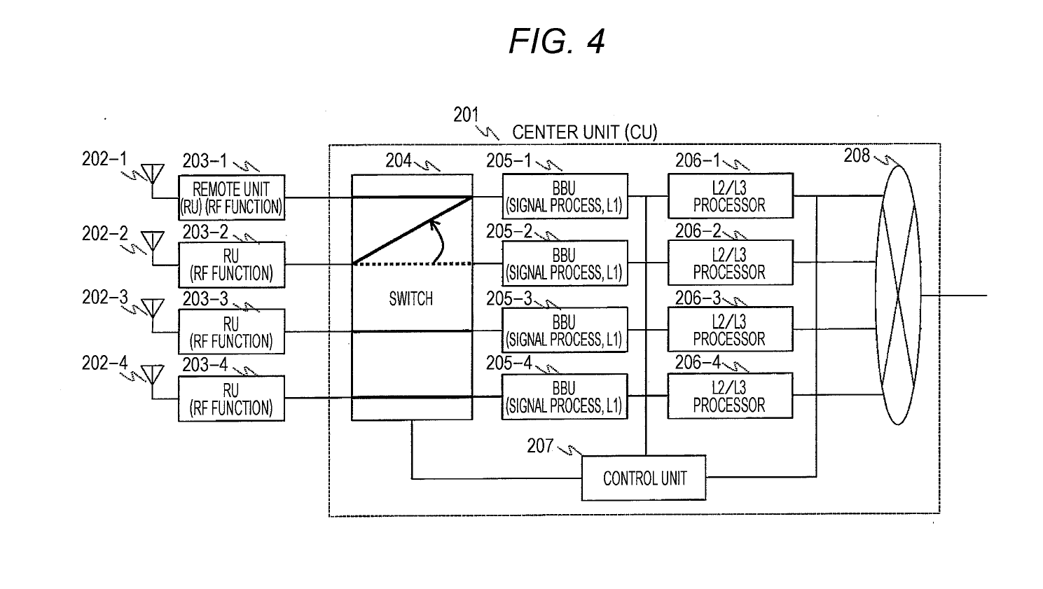

FIG. 4 illustrates an example of the configuration of CU 201 and RU 203 according to the present embodiment. The device illustrated in FIG. 4 may be realized by a memory, a digital signal processor (DSP), a field programmable gate array (FPGA), a central processing unit (CPU), a micro-processing unit (MPU) and the like.

CU 201 and RU 203 are connected by a wired line such as an optical fiber line, or a wireless line. RU 203 is also connected to an antenna 202. However, RF function and the antenna 202 may be incorporated into RU 203.

The antenna 202 transmits a downlink radio frequency (RF) signal input from RU 203. The antenna 202 also receives an uplink RF signal transmitted from the terminal. A plurality of antennas may be connected to one RU 203.

RU 203 is provided with an RF function. RU 203 converts a downlink base band IQ signal input from CU 201 into an RF signal which is transmitted via the antenna 202. RU 203 also converts an uplink RF signal input from the antenna 202 into a base band IQ signal which is input to CU 201. RU 203 includes an electric power amplifier. RU 203 is provided with an interface between RU 203 and CU 201. For example, when RU 203 and CU 201 are connected via an optical fiber, RU 203 may include an electrical/optical converter and an optical/electrical converter. RU 203 is further provided with a signal transmission/reception function based on a common public radio interface (CPRI), and may perform signal transmission and reception with CU 201 using a plurality of antennas or a plurality of frequencies.

CU 201 includes a switch 204, a base band unit (BBU) 205, an L2/L3 processor 206, a control unit 207, and a network interface (I/F) 208.

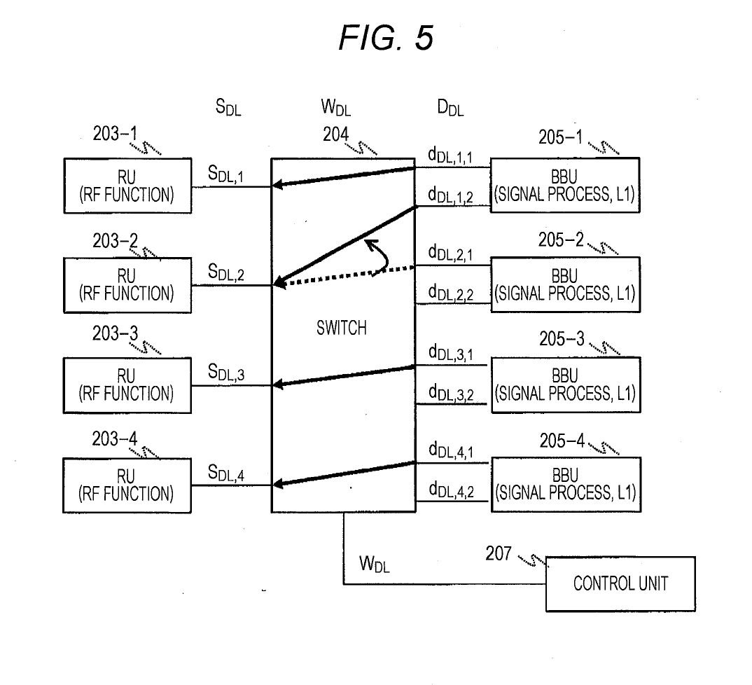

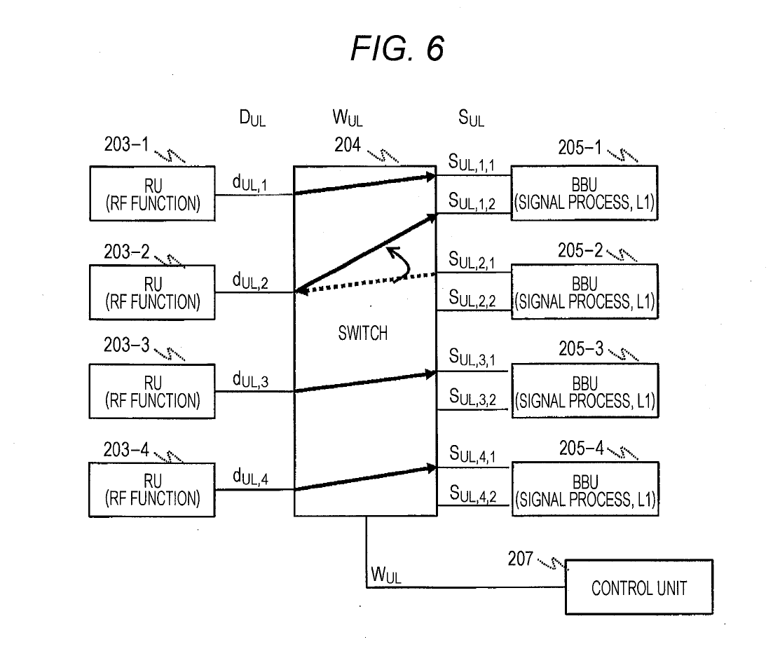

The switch 204 connects BBU 205 and RU 203. The correspondence between BBU 205 and RU 203 is notified by the control unit 207. The connection between BBU 205 and RU 203 may be one-to-one or one-to-many. For example, when each RU 203 has a different cell ID, one RU 203 is connected to one BBU 205. When an identical cell ID is allocated to a plurality of RUs 203, the plurality of RUs 203 are connected to one BBU 205. The connection may include an adjustment of signal power (amplitude) or a weighted average. The details of such connecting operations in the switch may be implemented in the form of a matrix operation illustrated in FIGS. 5 and 6, for example.

BBU 205 includes the function of outputting signals corresponding to a plurality of RUs 203. Each output from BBU 205 may correspond to one signal process device (such as DSP), for example. When the signal input from BBU 205 to the switch 204 is expressed by a vector D_{DL} of 2*number of BBUs rows and one column, the output from the switch 204 (input to RU 203) is expressed by a vector S_{DL} of the number of RUs rows and one column, and the connection in the switch is expressed by a matrix W_{DL} of the number of RUs rows and 2*number of BBUs columns, the relationship between D_{DL}, S_{DL}, and W_{DL} can be expressed by Mathematical Formula 1.

S_{DL}=W_{DL}D_{DL} [Mathematical Formula 1]

In the example of FIG. 5, D_{DL}=[d_{DL, 1, 1} d_{DL, 1, 2} d_{DL, 2, 1} d_{DL, 2, 2} d_{DL, 3, 1} d_{DL, 3, 2} d_{DL, 4, 1} d_{DL, 4, 2}]^{T}, and S_{DL}=[s_{DL, 1} s_{DL, 2} s_{DL, 3} s_{DL, 4}]^{T}, where d_{DL, i, j} is a j-th output signal of BBU 205-i, and s_{DL, i} is an output signal from the switch 204 to RU 203-i. For example, when a different cell ID is allocated to each RU 203, i.e., when BBU 205 and RU 203 are connected one-to-one, the downlink connection matrix W_{DL} can be expressed according to Mathematical Formula 2.

$${W}_{DL} = [ \begin{matrix}1 & 0 & 0 & 0 & 0 & 0 & 0 & 0 \\ 0 & 0 & 1 & 0 & 0 & 0 & 0 & 0 \\ 0 & 0 & 0 & 0 & 1 & 0 & 0 & 0 \\ 0 & 0 & 0 & 0 & 0 & 0 & 1 & 0\end{matrix} ] \qquad [ Mathematical Formula 2 ]$$

Mathematical Formula 2 indicates that only the first output from each BBU 205 is output to RU 203. Alternatively, when BBU 205 and RU 203 are connected one-to-one, the downlink connection matrix W_{DL} according to Mathematical Formula 3 may be used.

$${W}_{DL} = [ \begin{matrix}1 & 1 & 0 & 0 & 0 & 0 & 0 & 0 \\ 0 & 0 & 1 & 1 & 0 & 0 & 0 & 0 \\ 0 & 0 & 0 & 0 & 1 & 1 & 0 & 0 \\ 0 & 0 & 0 & 0 & 0 & 0 & 1 & 1\end{matrix} ] \qquad [ Mathematical Formula 3 ]$$

Mathematical Formula 3 indicates that a sum of signals output from BBU 205 is transmitted to RU 203. In this case, each output from BBU 205 is, for example, a layer-by-layer signal or a user-by-user signal.

When an identical cell ID is allocated to RUs 203-1 and 203-2, and RUs 203-1 and 203-2 are connected to BBU 205-1, the downlink connection matrix W_{DL} can be expressed by Mathematical Formula 4.

$${W}_{DL} = [ \begin{matrix}1 & 0 & 0 & 0 & 0 & 0 & 0 & 0 \\ 0 & 1 & 0 & 0 & 0 & 0 & 0 & 0 \\ 0 & 0 & 0 & 0 & 1 & 0 & 0 & 0 \\ 0 & 0 & 0 & 0 & 0 & 0 & 1 & 0\end{matrix} ] \qquad [ Mathematical Formula 4 ]$$

Mathematical Formula 4 indicates that a second output from BBU 205-1 is output to RU 203-2, as illustrated in FIG. 5. By using a value other than 1 as the coefficient in Mathematical Formula 2, the power can be adjusted. The connection matrix W_{DL} is provided from a control unit 207.

Similarly, in uplink, when the signal input from RU 203 to the switch 204 is expressed by a vector D_{UL} of the number of RUs rows and one column, the output from the switch 204 (input to BBU 205) by a vector S_{UL} of a 2*number of BBUs rows and one column, and the connection in the switch by a matrix W_{UL} of 2*number of BBUs rows and number of RUs columns, the relationship between D_{UL}, S_{UL}, and W_{UL} can be expressed by Mathematical Formula 5.

S_{UL}=W_{UL}D_{UL} [Mathematical Formula 5]

In the example of FIG. 6, the uplink connection matrix W_{UL} in the case where an identical cell ID is allocated to RUs 203-1 and 203-2 can be expressed by Mathematical Formula 6.

$${W}_{UL} = [ \begin{matrix}1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 0 & 0 \\ 0 & 0 & 0 & 1 \\ 0 & 0 & 0 & 0\end{matrix} ] \qquad [ Mathematical Formula 6 ]$$

Alternatively, when BBU 205 and RU 203 are connected one-to-one, the same signal may be input to a plurality of inputs of BBU 205 as according to Mathematical Formula 7.

$${W}_{UL} = [ \begin{matrix}1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 1 & 0 \\ 0 & 0 & 0 & 1 \\ 0 & 0 & 0 & 1\end{matrix} ] \qquad [ Mathematical Formula 7 ]$$

The connection between BBU 205 and RU 203 in the switch 204 may be realized by another method. For example, for downlink, signals input from BBU 205 to the switch may include information of destination RU 203, and the signals may be sorted in the switch 204. For uplink, signals input from a plurality of RUs 203 may be weighted and summed, and the weighted sum may be output to one BBU 205.

BBU 205 mainly performs a signal process in the physical layer (L1, Layer 1). For example, BBU 205 performs a physical layer signal process of a downlink physical data channel (which may be referred to as physical downlink shared channel (PDSCH)) or a physical control channel (which may be referred to as physical downlink control channel (PDCCH), Enhanced PDCCH, physical hybridARQ indicator channel (PHICH), or physical control format indicator channel (PCFICH)) of each terminal that is input from the L2/L3 processor 206, or generates a physical layer control channel. BBU 205 also performs a physical layer signal process of an uplink data channel (physical uplink shared channel (PUSCH)) and a control channel (physical uplink control channel (PUCCH)) and the like that is input from RU 203 via the switch 204. Specifically, the downlink signal process may include error-correcting coding of a data signal and a control signal, rate matching, modulation, a MIMO signal process such as layer mapping or precoding, mapping to a wireless resource (which may be referred to as a resource element (RE)), or inverse fast Fourier transform (IFFT). BBU 205 also performs generation of reference signals (such as CRS, CSI-RS, and DMRS) for channel estimation for demodulation, CSI measurement, or reception power measurement by the terminals, and insertion of the reference signals in the wireless resource. BBU 205 also performs generation of synchronization signals and a physical layer broadcast channel (physical broadcast channel (PBCH)) and their insertion in RE. As illustrated in FIG. 5 or FIG. 6, BBU 205 has the function of performing a signal process corresponding to a plurality of RUs 203. BBU 205 may also include the function of switching between a signal process corresponding to a plurality of RUs 203 and a signal process corresponding to a single RU 203 under the control of the control unit 207 or the L2/L3 processor 206. A base band signal generated by the signal processes is transmitted via the switch 204 to RU 203. The uplink signal process includes FFT, RE demapping, a MIMO signal process such as multiplication of a MIMO reception weight or layer demapping, demodulation, and error-correcting demodulation for the signals input via the switch 204 from RU 203. BBU 205 also performs channel estimation and reception power measurement using an uplink RS (such as DMRS or Sounding RS (SRS), uplink CSI measurement and the like. The decoded data channel or control channel, various measurement results and the like are transmitted to the L2/L3 processor 206. The result of uplink reception power measurement may be reported to the control unit 207.

The L2/L3 processor 206 is a processor that performs Layer 2 and Layer 3 processes of the base station. The L2/L3 processor 206 stores respective terminal data transmitted from the core network via the network I/F 208, and control signals received from another base station or a mobility management entity (MME) in a buffer. The L2/L3 processor 206 also performs, e.g., scheduling for determining a terminal for communication or the time and frequency resources allocated to the terminal, HARQ management, packet processing, a wireless line hiding process, and generation of a control signal of an upper layer to a terminal. The L2/L3 processor 206 also determines, based on a measurement report reported from the terminal 106 or uplink reception power information, whether the terminal 106 is positioned at the center of the communication area of each RU 203 or at the boundary of communication areas. The L2/L3 processor 206 also notifies the control unit 207 of information about the terminal positioned near the boundary of communication areas, a measurement result of uplink reception power and the like. Depending on the result of determination of the terminal positioned area, the L2/L3 processor 206 also makes a determination of RU 203 to which the signal from each terminal is transmitted, a transmission mode setting and the like. The L2/L3 processor 206 includes the function of switching the signal process corresponding to a plurality of RUs 203 and a process corresponding to a single RU 203 under the control of the control unit 207.

The control unit 207, based on the uplink reception power information of each terminal notified from the L2/L3 processor 206 or BBU 205, the information of the terminal positioned in the communication area of each RU 203 and the like, detects a set of RUs 203 of which a number of terminals are distributed near the boundary of communication areas. Then, the control unit 207 allocates an identical cell ID to the detected RUs 203, modifies the connection in the switch 204, and notifies connection information to the switch 204. The connection information may also be notified to BBU 205 and the L2/L3 processor 206.

The network I/F 208 provides an interface for connecting CU 201 and the core network through a backhaul line. The network I/F 208 transfers to the core network data and control information of each terminal input from the L2/L3 processor, control information or the like to another base station, or the mobility management entity. The network I/F 208 also transfers data or control information of each terminal and control information and the like for the L2/L3 processor 206, which are input from the core network, to the corresponding L2/L3 processor 206. The network I/F 208 may include the function of managing movements, such as a handover, that takes place in CU 201. Namely, the network I/F may include the function of a local gateway in CU 201, or as a mobility management entity.

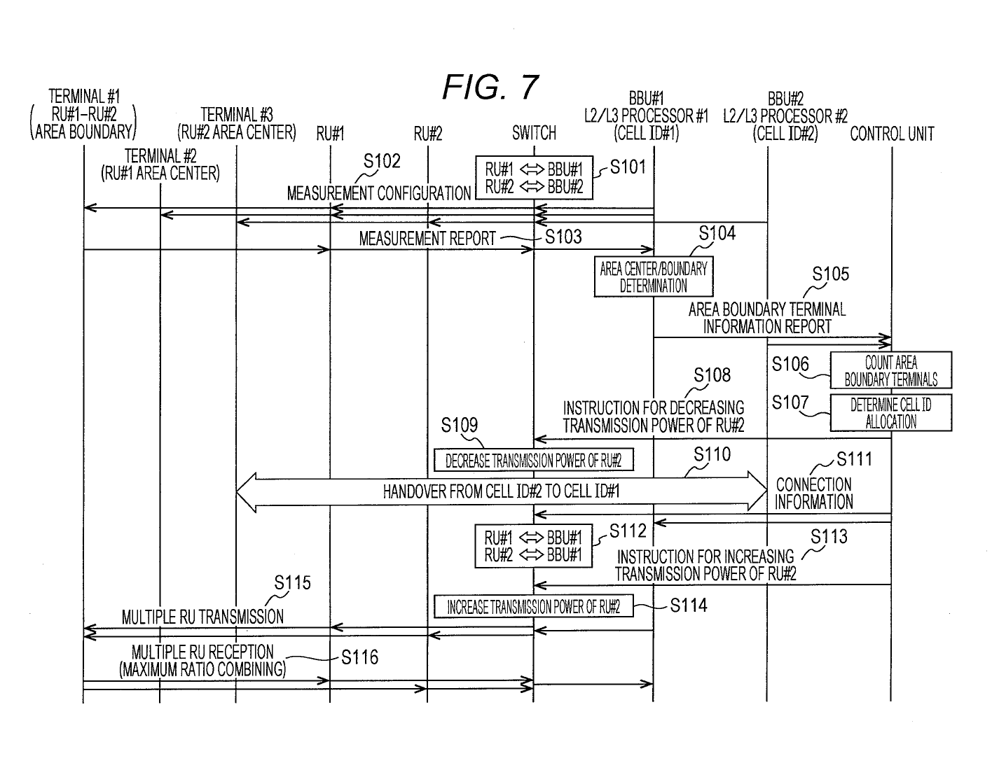

FIG. 7 illustrates an example of an operation sequence up to cell ID modification according to the first embodiment of the present invention. While in FIG. 7, two RUs (RU #1 and RU #2), and two BBUs and two L2/L3 processors (BBU #1 and BBU #2, L2/L3 processor #1 and L2/L3 processor #2) are described, other RUs and BBUs that are not described may be present. The number of terminals is three, with terminal #1 positioned near the boundary of the communication areas of RU #1 and RU #2 (corresponding to the terminal 106-2 in FIG. 2). In the illustrated example, communication with BBU #1 is conducted using RU #1. Terminal #2 is positioned at the center of the communication area of RU #1 (corresponding to the terminal 106-1 in FIG. 2). Terminal #3 is positioned at the center of the communication area of RU #2 (corresponding to the terminal 106-3 in FIG. 2). In the initial state, it is assumed that the switch connects RU #1 and BBU #1, and RU #2 and BBU #2 (S101).

The L2/L3 processors #1 and #2 make reception power information measurement and report settings (measurement configuration) in the respective terminals #1 to #3 to determine whether the terminals are at the boundary of the communication areas of RU #1 and RU #2 (S102). The measurement configuration set here is referred to as an event A3, for example. The event is generated when the reception power of an adjacent cell becomes greater than the sum of the reception power of a connected cell (referred to as a “serving cell”) and a predetermined offset value. For example, when the offset value is set at −3 dB, the terminals #1 to #3 start reporting of the reception power of the cell when the difference between the reception power of the connected cell and the reception power of the adjacent cell is 3 dB or less. The report is referred to as a measurement report. The terminal making the measurement report can be determined to be a terminal positioned at the boundary of the communication areas of RU #1 and RU #2. The report may be caused (by setting of On/Off of parameter reportOnLeave) to be made when the cell ceased to satisfy the above condition. The measurement configuration that is set herein may be common with the one set for a handover, and an offset value larger than the handover may be set. In the example of FIG. 7, it is assumed that the terminal #1 satisfies the present condition, and reports the cell IDs of the connected cell and the adjacent cell, reception power and the like (S103). The L2/L3 processor #1 determines that the terminal #1 that has made the measurement report is positioned at the boundary of the communication areas of RU #1 and RU #2 (S104). The L2/L3 processors #1 and #2 count, of the connected terminals, the number of terminals that satisfy the condition set in S102, and the number of terminals that do not (i.e., the terminals that do not make the measurement report). Then, the L2/L3 processors #1 and #2 periodically report information to the control unit, such as the number of the terminals satisfying the measurement configuration condition set in S102, the cell ID of the adjacent cell satisfying the condition, and the number of the terminals not satisfying the condition (S105).

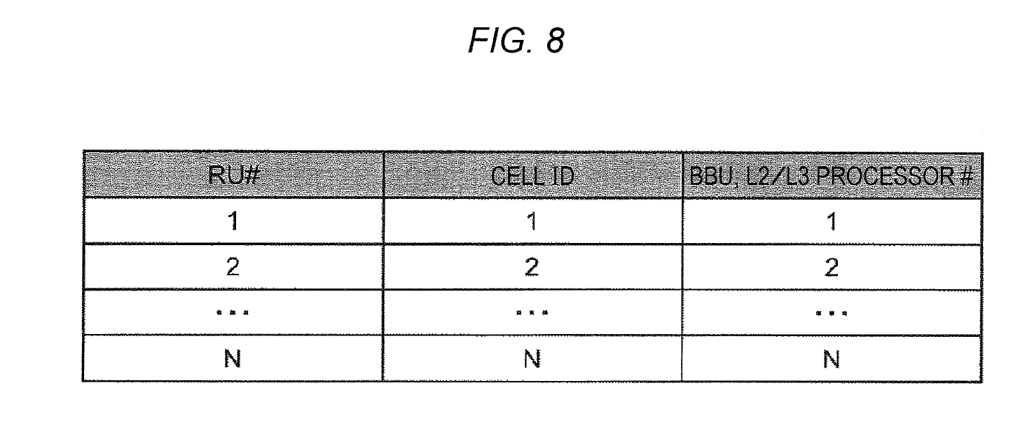

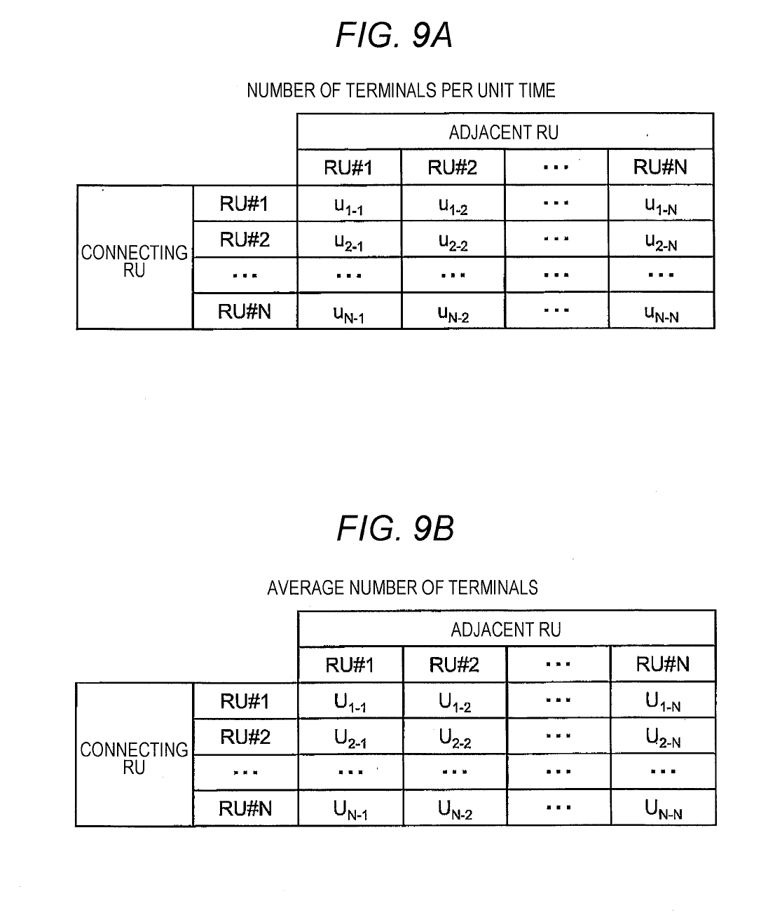

The control unit, based on the information about the terminals at the communication area boundary reported from each L2/L3 processor, computes the number of the terminals at the communication area boundary of each RU per unit time, and an average number of the terminals at the area boundary (S106). For example, the control unit stores each RU number, the allocated cell ID, and the L2/L3 processor number in association with one another in a RU/cell ID mapping table illustrated in FIG. 8. The control unit then refers to FIG. 8 and computes the RU number corresponding to the cell ID reported in S104. Herein, the RU corresponding to the connected cell is referred to as a connected RU, and the RU corresponding to the adjacent cell is referred to as an adjacent RU. Then, the reported number of terminals is saved in a format as shown in FIG. 9A. The diagonal component uᵢ₋ᵢ in FIG. 9A indicates the number of the terminals positioned at the center of the communication area of RU #i, and the non-diagonal component uᵢ₋ⱼ indicates the number of the terminals positioned at the boundary of the communication areas of RU #i and RU #j, with RU #i having greater reception power (RU #i providing the connected RU). The control unit also stores the average number of the terminals at the area boundary in a format as shown in FIG. 9B. The control unit updates the information about the average number of terminals periodically (such as each time the information of the number of terminals is reported from the L2/L3 processor). The averaging may be performed by computing a forgetting average according to Mathematical Formula 8, for example.

Uᵢ₋ⱼ=(1−α)Uᵢ₋ⱼ+αuᵢ₋ⱼ [Mathematical Formula 8]

wherein α is a forgetting coefficient.

Then, the control unit, based on the computed number of terminals at the communication area boundary, makes a cell ID allocation determination for each RU (S107). A concrete method for the allocation determination will be described later. Herein, it is assumed that the control unit has determined to allocate an identical cell ID to RU #1 and RU #2.

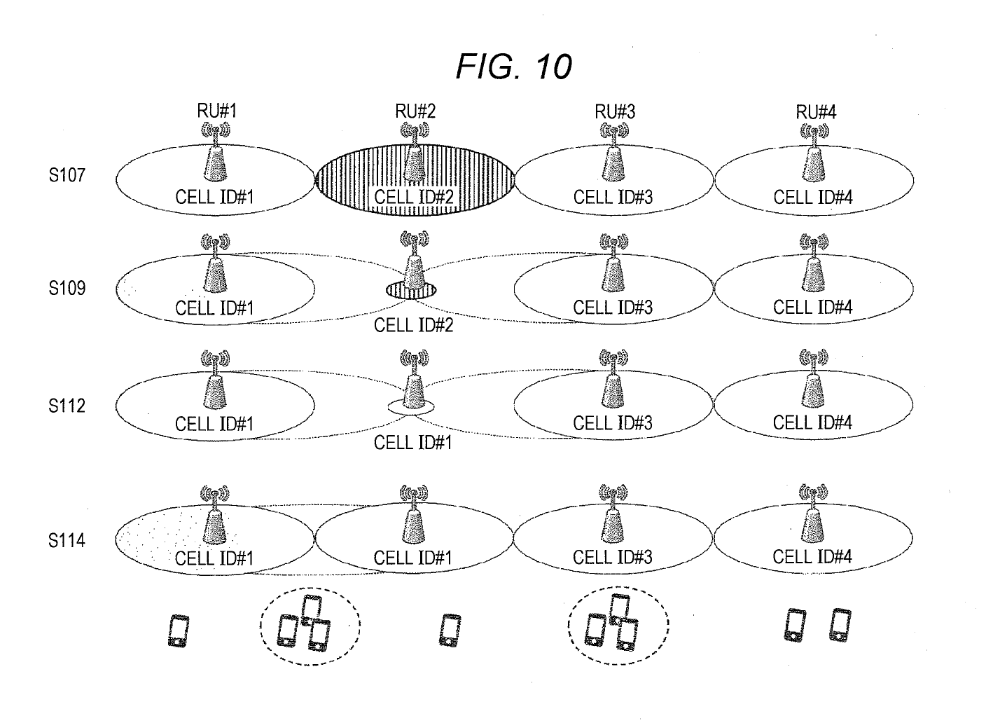

Thereafter, switch connection control is performed from S108 to S114. How the communication area of each RU is changed by the present operation is illustrated in FIG. 10. If the cell ID of the signal transmitted by each RU is instantaneously modified, the cell prior to the modification would cease to exist all of a sudden, creating the possibility of disconnecting the terminal that has been connected to the cell prior to the modification. The operation from S108 to S114 represents a method for minimizing the influence of the cell ID modification on the terminal. First, the control unit notifies the switch requesting a decrease in the transmission power of the other RU to which the identical cell ID is allocated (S108). The switch, in accordance with the notification from the control unit, decreases the transmission power of RU #2 (S109). The present operation is repeated a certain number of times at certain periods, for example. As a result, the communication area of RU #2 is reduced, as illustrated in FIG. 10. Thus, the terminals that have been connected to RU #2 are handed over to the cell of another RU (S110). In FIG. 7, it is assumed that the handover occurs from the cell of RU #2 (cell ID #2) to the cell of RU #1 (cell ID #1). When the terminal connected to the RU prior to the modification (RU #2 in FIG. 7 or FIG. 10) ceases to be present, or when the transmission power is decreased by a certain amount, the control unit notifies the switch of the connection information of BBU and RU determined in S107 (S111). The establishment of connections with a plurality of RUs is also notified to the L2/L3 processor #1 or BBU #1. The switch, based on the connection information from the control unit, makes a connection modification (S112). In FIG. 7, both RU #1 and RU #2 are connected to BBU #1. As a result, RU #1 and RU #2 have the same cell ID. Then, the control unit, in order to return the reduced area of the RU back to the original area, notifies the switch requesting an increase in transmission power (S113). The switch, in accordance with the notification from the control unit, increases the transmission power of RU #2 (S114). The operation of S113 and S114 is also repeated a certain number of times at certain periods. As a result, as illustrated in FIG. 10, the communication area of RU #2 is returned to the original state. S108, S111, and S113 may be implemented by notifying the switch of the notified downlink and uplink connection matrices W_{DL} and W_{UL}.

As a result of the above operation, RU #1 and RU #2 are provided with the identical cell ID. However, BBU #1, immediately after connection modification, is not cognizant of whether each terminal is positioned at the center of the communication area of RU #1, the center of the communication area of RU #2, or at the boundary of the communication areas of RU #1 and RU #2. Thus, immediately after the connection control, transmission is performed to all of the terminals using a plurality of RUs (S115). As to reception, BBU #1 may receive the signals from the plurality of RUs which may be combined at a maximum ratio, simply added up, or averaged, assuming that the number of antennas has been doubled (S116).

However, the determination from S102 to S106 regarding the boundary of the communication area of RU may be implemented by other methods. For example, each terminal measures the position of the terminal using GPS and the like, and notifies the L2/L3 processor of the measured position. When the distance between the terminal and a plurality of RUs is within a certain threshold value, the L2/L3 processor may determine that the terminal is positioned at the boundary of the communication areas of the RUs.

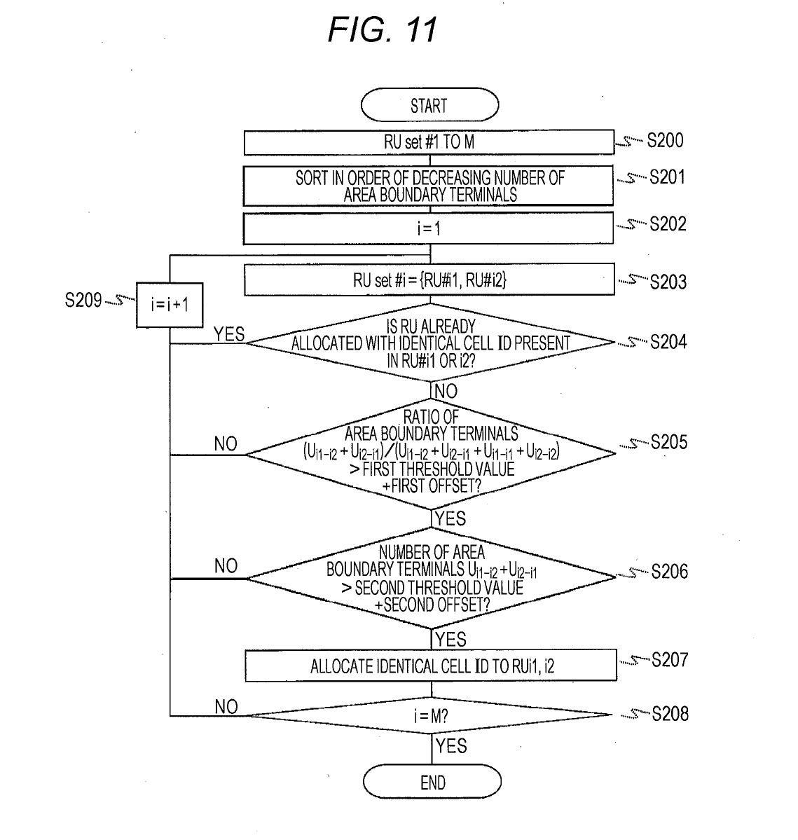

FIG. 11 illustrates an example of the method for cell ID allocation determination in S107 of FIG. 7. In the example method of FIG. 11, based on the number of the terminals positioned near the boundary of the communication areas of RU and the ratio of the terminals, it is determined whether an identical cell ID should be allocated based on a detection of a number of terminals positioned at the boundary of the communication areas.

When a set of RUs is referred to as an RU set, the possible number M of RU sets is N (N−1)/2, where N is the number of RUs (S200). The control unit sorts RU sets #1 to #M in order of decreasing number of terminals positioned at the boundary of the communication areas of the RU set (S201). However, in S201, the sorting may be in order of decreasing ratio of the terminals positioned at the boundary of the communication areas. First, a determination is made with respect to the first RU set (S202). Here, the RUs of the i-th RU set #i are assumed to be RU #i1 and RU #i2 (i1<i2) (S203). The control unit checks to see if the cell ID identical to that of another RU (S204) is allocated to RU #i1 or RU #i2. It should be noted, however, that the determination in S204 is whether the cell ID has been allocated in S207 which will be described below, and not whether the identical cell ID is currently actually allocated. If there is an RU in RU #i1 or #i2 to which the identical cell ID is already allocated (Yes), the process proceeds to the next RU set (S209). If not (No), the control unit determines whether the ratio of the area boundary terminals of RU set #i exceeds a predetermined first threshold value to which a first offset is added (S205). The number of terminals at the area boundary can be computed by adding up transposed elements of the non-diagonal components in FIG. 9B. For example, the number of the terminals at the area boundary of RU #i and RU #j is Uᵢ₋ⱼ+Uⱼ₋ᵢ. The ratio of the terminals at the area boundary can be computed by (Uᵢ₋ⱼ+Uⱼ₋ᵢ)/(Uᵢ₋ⱼ+Uⱼ₋ᵢ+Uᵢ₋ᵢ+Uⱼ₋ⱼ). If the ratio of the terminals at the area boundary of RU set #i does not exceed the value of the first threshold value to which the first offset is added (No), it is determined that the RU set has another cell ID, and the process proceeds to the next RU set. If the ratio of the terminals at the area boundary of RU set #i exceeds the value of the first threshold value to which the first offset is added (Yes), the control unit determines whether the number of terminals Uᵢ₁+Uᵢ₂ at the area boundary of RU set #i exceeds the value of a predetermined second threshold value to which a second offset is added (S206). If the number of terminals at the area boundary of RU set #i does not exceed the value of the second threshold value with the added second offset (No), it is determined that the RU set has another cell ID, and the process proceeds to the next RU set. If the number of terminals at the area boundary of RU set #i exceeds the value of the second threshold value with the added second offset (Yes), the control unit determines that an identical cell ID is to be allocated to the RU set (S207). Then, it is checked to see if the determination has been made with respect to all of the RU sets. If “Yes”, the process ends; if “No”, the process proceeds to the next RU set (S208). Thus, by allocating the identical cell ID to the RU where the number of the terminals positioned at the boundary of the communication areas of RU and its ratio are large, the communication quality can be improved in the area where the problem of degradation of communication quality due to inter-cell interference and a decrease in communication efficiency due to handover is the most pronounced, thus decreasing handover.

The present determination method may also be used when an RU to which an identical cell ID has been allocated is again allocated another cell ID, or when the cell ID identical to that of the other RU is allocated to the RU. The first offset and the second offset are offsets for varying the threshold value for determination depending on whether the identical cell ID has been already allocated to a plurality of RUs. For example, when the particular RU set is already operating as the same cell, the first or second offset may be given a negative value; otherwise, a positive value or 0 may be given. As a result, the RU set already operating as the identical cell ID is unlikely to assume a different cell ID, while the identical cell ID is more likely to be allocated to an RU set that is not operating as such. Alternatively, the opposite offsets may be set.

Only one of S205 and S206 may be implemented. Whether only one of the steps is to be implemented may be controlled by making the first threshold value or the second threshold value zero.

In S205 or S206, other references may be used, or an additional reference may be used. For example, the determination may be made based on the amount of traffic of the terminal's at the area boundary, or a traffic ratio, instead of the number of the terminals at the area boundary. Namely, an identical cell ID may be allocated to the RU when the amount of traffic of the terminals at the area boundary, its ratio, or both exceed certain threshold values. On the other hand, when the amount of traffic of the terminals at the area boundary or its ratio is small, the communication speed (or the modulation scheme and coding rate) of the terminals may be lowered so as to increase the amount of allocated wireless resources, thus addressing the decrease in communication quality. The influence of the increase in the amount of allocated wireless resources on the terminals at the area center is small. Thus, when the amount of traffic of the terminals at the area boundary, or its ratio is small, the necessity of allocating an identical cell ID to a plurality of RUs is low. Accordingly, by performing the cell ID allocation by taking the amount of traffic of the terminals at the area boundary or its ratio into consideration, the influence of cell ID modification on the terminals at the area center can be minimized. It also becomes possible to increase the communication quality in the area where the problem of inter-cell interference is most pronounced, thus decreasing handover. Alternatively, the terminals supporting the CoMP function may not be counted as the terminals at the area boundary in consideration of the fact that the communication quality can be increased by CoMP. While in FIG. 11, the number of RUs to which the identical cell ID is allocated is two, the method of FIG. 11 may be readily extended for more than two RUs, and may not be limited to the number two.

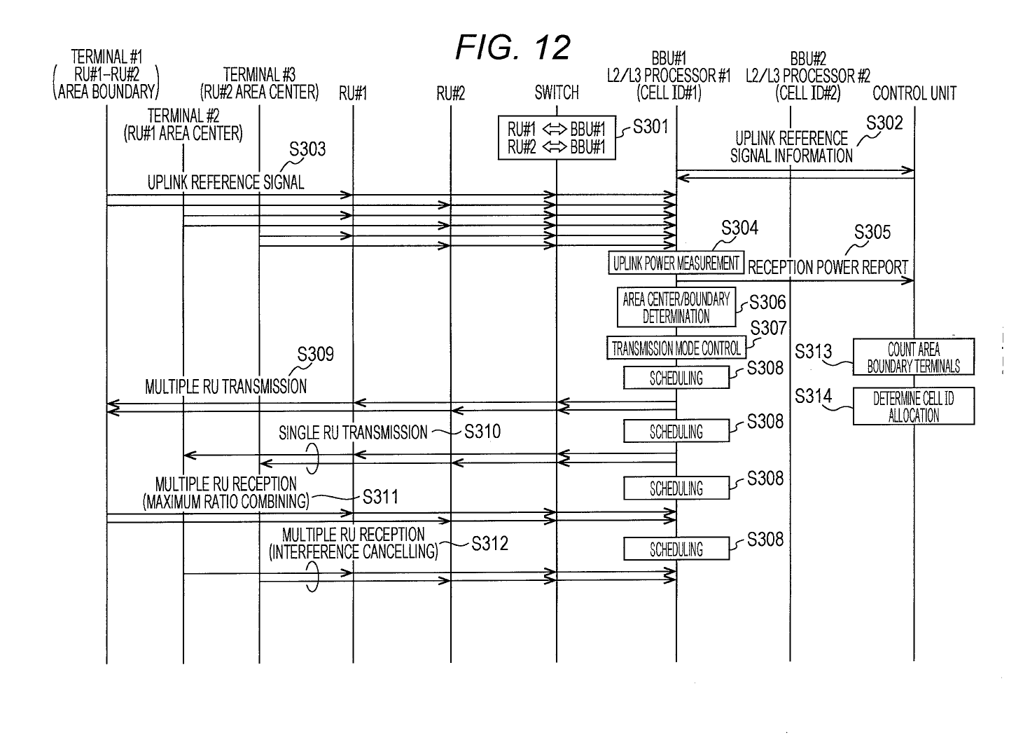

FIG. 12 shows an example of the operation sequence according to the first embodiment where a plurality of RUs have the same cell ID. In the RUs to which the identical cell ID is allocated, the same synchronization signal, reference signal (CRS), broadcast signal and the like are transmitted. Thus, the terminals cannot distinguish the RUs having the identical cell ID. Specifically, the reception power of each cell as reported by the terminals is a combination of the reference signals transmitted from the RUs having the identical cell ID. Thus, the CU detects, through the following procedure, the communication area of which RU each terminal is positioned in. In FIG. 12, it is assumed that RU #1 and RU #2 are allocated the same cell ID and are connected to the same BBU #1 (S301). The L2/L3 processor #1 notifies the control unit of the setting information of uplink reference signals (which may be referred to as Sounding RS (SRS)) of the connected terminals. The L2/L3 processor #1 also receives from the control unit information of uplink reference signals of the terminals connected to the other BBU and L2/L3 processor (S302). The information of uplink reference signals include, for example, the cell ID of the measured cell, the ID of the terminals whose uplink reference signals are transmitted, a transmission period and a transmission timing, and a frequency resource. Each terminal periodically transmits the uplink reference signal (S303). The BBU #1 measures the reception power of the uplink reference signal transmitted from each terminal at RU #1 and RU #2 (S304). The reception power is averaged by computing a forgetting average or a time average, for example. The measurement of the uplink reception power is also performed with regard to the uplink reference signals of the terminals connected to the other BBU and L2/L3 processor on the basis of the information notified in S302. The control unit is notified of the measured reception power, together with the ID of RU, the ID of the terminals, and the ID of the cell to which the terminals are connected (S305). BBU #1 determines, based on the reception power of RU #1 and RU #2 measured in S304, whether each terminal is positioned at the boundary of the communication areas of RU #1 and RU #2, or at the center of the communication area of RU #1 or RU #2 (S306). For example, as in the case of FIG. 7, when the difference in reception power between RU #1 and RU #2 is not greater than a certain threshold value, the L2/L3 processor #1 determines that the terminal is positioned at the boundary of the communication areas of RU #1 and RU #2. When the difference in reception power is greater than the threshold value, the L2/L3 processor determines that the terminal is positioned at the center of the communication area of the RU having the maximum reception power. Then, the L2/L3 processor, based on the area boundary information of each terminal determined in S304, controls the transmission mode (S307) and performs scheduling (S308), for example.

For example, the transmission mode is controlled (S307) as follows. As described above, for the terminals positioned at the center of the communication area of RU #1 or RU #2 to which an identical cell ID is allocated (such as terminals #2 and #3 in FIG. 12), it is believed that the available amount of wireless resources can be effectively increased by having the terminals communicate using a single RU. Thus, a transmission mode using DMRS (such as TM7, 8, 9, or 10) is set. On the other hand, for the terminals positioned near the boundary of the communication areas of RU #1 and RU #2, it is believed that the communication quality can be effectively increased by having the terminals communicate using a plurality of RUs. Thus, a transmission mode using CRS (such as TM 1 to 4) is set.

Also, with regard to the terminals positioned at the boundary of the communication areas of RU #1 and RU #2, the terminals of which the difference in reception power between RU #1 and RU #2 measured in S304 is not greater than a threshold value A (e.g., 3 dB) have the possibility of a significant decrease in communication quality when transmitting with a single RU. Thus, assuming that a plurality of RUs will be used at all times, a transmission mode using CRS may be set. Meanwhile, for the terminals of which the difference in reception power is greater than the threshold value A but not greater than a threshold value B (e.g., 9 dB), transmission using a plurality of RUs and transmission using a single RU may be switched depending on the situation. Thus, a transmission mode using DMRS may be set. Further, the transmission mode may be controlled depending on the transmission mode support situation notified by the terminal. For example, a terminal not supporting the transmission mode using DMRS may set a transmission mode using CRS, while a terminal supporting the transmission mode using DMRS may set a transmission mode using DMRS.

In another method, the transmission mode may be controlled depending on the mobility situation of the terminal. For example, a terminal with high speed of movement may be set for a transmission mode using CRS, while a terminal with low speed of movement may be set for a transmission mode using DMRS. The terminal with high speed of movement, even if positioned at the center of the communication area of a certain RU, has the high probability of moving to the boundary of the communication area of the RU or to the center of the communication area of a different RU in a short time. Thus, it may become necessary to reconfigure the transmission mode frequently, or the modification of the transmitting RU may not be able to catch up with the movement of the terminal. Accordingly, by setting a transmission mode using CRS for the terminal with high speed of movement and performing transmission using a plurality of RUs, the frequent reconfiguration of the transmission mode or the modifying of the transmitting RU can be avoided. The transmission mode thus controlled is notified from the L2/L3 processor #1 to the respective terminals #1 to #3.

The scheduling (S308) may be performed as follows, for example. First, a metric for scheduling in the case of transmission using a plurality of RUs is computed, and a terminal of which the metric becomes maximum is extracted. The metric in the case where the plurality of RUs are used is computed only for the terminals positioned at the area boundary of RU #1 and RU #2. It is assumed that the terminal extracted herein is u1-2, and the metric for scheduling is metric 1-2. As the metric for scheduling, a proportional fairness (PF) metric may be used, for example. The PF metric is an instantaneous throughput divided by an average throughput. The instantaneous throughput can be computed from the CQI reported by the terminal, or from the CQI estimated or corrected in CU. Similarly, the metric for scheduling in the case where a single RU, i.e., RU #1 or RU #2, is used for communication is computed. The metric in the case where the single RU is used for communication is computed for the terminal of which the reception power of RU #1 or RU #2 becomes maximum. In this case, the terminals of which the reception power of each RU becomes maximum may include only the terminals positioned at the area center of RU #1 or RU #2, and terminals positioned at the area boundary of RU #1 and RU #2. Then, the terminals of which the metric is maximized with respect to each RU are extracted. It is assumed that the extracted terminals are u1 and u2, and the metrics for scheduling are metric 1 and metric 2. When the following Mathematical Formula 9 is satisfied, u1-2 is scheduled.

Metric 1−2>Metric 1+Metric 2 [Mathematical Formula 9]

When the Mathematical Formula 9 is not satisfied, both u1 and u2 are scheduled. u1-2 and either u1 or u2 may be the same terminal. The scheduling using such metrics may be performed on a unit time (Subframe) basis, on a minimum unit wireless resource (Resource Block (RB)) basis, or for each sub-band including a plurality of RBs.

In the same terminal, whether the terminal is the object for transmission using a plurality of RUs or a single RU may be controlled depending on the type of data transmitted. For example, with regard to traffic for control purpose (control plane traffic: C-plane traffic) for which communication stability is important, a plurality of RUs may be used for transmission regardless of whether the terminal is at the area boundary or center. On the other hand, with regard to data traffic for which wireless capacity is important (user-plane traffic: U-plane traffic), the terminal may be the object of transmission using a single RU as long as the terminal is positioned at the center of the communication area of RU. Alternatively, with regard to real-time traffic among the data traffic for which stability is important, such as audio and video, a plurality of RUs may be used for transmission regardless of whether the terminal is at the area boundary or center. Meanwhile, in the case of data traffic, for best effort traffic for which wireless capacity is important, such as for Web browsing, the terminal may be the object for transmission using a single RU as long as the terminal is positioned at the center of the communication area of RU.

The L2/L3 processor #1 and BBU #1, based on the scheduling result in S307 as described above, performs data transmission and reception using various methods. An example will be described with reference to S309 to S312 in FIG. 12. When the scheduling result indicates downlink data for the terminal #1 positioned at the area boundary of RU #1 and RU #2, BBU #1 performs transmission using a plurality of RUs, namely RU #1 and RU #2 (S309). At this time, the same signal is transmitted from RU #1 and RU #2. The transmission mode may be one using CRS or DMRS. When the scheduling result indicates downlink data of the terminal #2 positioned at the area center of RU #1 and the terminal #3 positioned at the area center of RU #2, BBU #1 performs a single RU transmission (S310). At this time, from RU #1, the data of the terminal #2 is transmitted, and from RU #2 the data of the terminal #3 is transmitted. At this time, the terminal #2 and the terminal #3 use DMRS. Further, in the terminal #2 and the terminal #3, different DMRS antenna ports or scramble sequences (SCID) are used. However, at this time, CRS is transmitted using a plurality of RUs (RU #1 and RU #2). Physical control channels demodulated using CRS, such as PDCCH, are also transmitted using a plurality of RUs (RU #1 and RU #2). When the scheduling result indicates the uplink data of the terminal #1 positioned at the area boundary of RU #1 and RU #2, BBU #1 performs multiple RU reception using RU #1 and RU #2 (S311). At this time, BBU #1 demodulates the signal received by each RU by maximum ratio combining. When the scheduling result indicates the uplink data of the terminal #2 positioned at the area center of RU #1 and the terminal #3 positioned at the area center of RU #2, BBU #1 performs multiple RU reception (S312). At this time, BBU #1 may perform demodulation by multi-user MIMO reception. For example, demodulation may be performed using an interference canceller that cancels out the interference of the signal of the terminal #3 to the signal of the terminal #2 in RU #1, and the interference of the signal of the terminal #2 to the signal of the terminal #3 in RU #2.

The control unit, based on the reception power of the uplink reference signal of each terminal at each RU that has been notified from the L2/L3 processor #1 and other L2/L3 processors which are not shown in S305, determines whether the terminal is at the boundary of the communication area of each RU, and counts the number of the terminals at the area boundary (S313). For the present operation, an inverse operation to the measurement configuration set in the terminal in S102 may be performed by the control unit. Namely, when the RU where the uplink reference signal reception power is at a maximum is the connected RU, and the other RU is an adjacent RU, if the reception power of the adjacent RU is within a certain offset value from the maximum reception power, the control unit determines that the terminal is positioned near the boundary of the communication areas of the connected RU and the adjacent RU. Otherwise, the control unit determines that the terminal is at the center of the communication area of the connected RU. The control unit performs the present determination on the unit time basis, and, based on the result, counts the number of terminals at the area boundary of the connected RU and the adjacent RU and the number of terminals at the area center per unit time, as in FIG. 9A. Also, as in FIG. 9B, the control unit computes an average number of terminals, and determines the cell ID allocated to each RU (S314). The method of cell ID allocation determination may be similar to the method in S107 of FIG. 7 or in FIG. 11. In accordance with the result of cell ID allocation in S314, the control unit re-allocates different cell IDs to the plurality of RUs to which an identical cell ID has been allocated, and switches the connection of BBU and RU. Alternatively, the control unit may newly allocate an identical cell ID to the RUs to which currently different cell IDs are allocated. Alternatively, the control unit may allocate, to the RUs to which currently an identical cell ID is allocated, the identical cell ID to that of another RU. Specifically, when the number of terminals at the communication area boundary of RUs having an identical cell ID or the ratio of such terminals is decreased to a value smaller than the value with the added threshold value in FIG. 11, the RUs are re-allocated different cell IDs. Alternatively, when the number of the terminals at the communication area boundary of one of RUs having an identical cell ID and another RU, or the ratio of such terminals is greater than the RUs currently having the identical cell ID and greater than the threshold value in FIG. 11, an identical cell ID to the other RU is allocated to the one RU. The operation sequence for modifying the cell ID of RU is similar to the sequence of S108 to S114 of FIG. 7.

The measurement of uplink reception power in S303 and S304 may be implemented using other signals. For example, a random access channel that is used when a terminal newly makes an access or performs uplink synchronization may be used.

### 2. Second Embodiment

In the second embodiment, it is contemplated that each RU uses a plurality of frequency carriers.

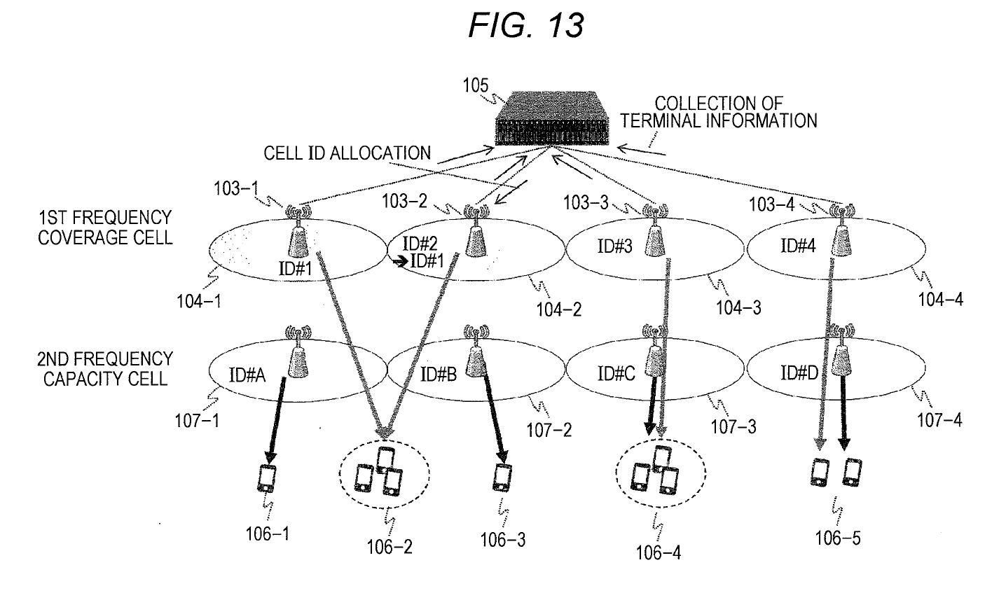

FIGS. 13 to 15 are conceptual diagrams for the second embodiment of the present invention. While the basic configuration is similar to FIG. 2, the second embodiment differs in that CU 105 and RU 103 include a transmission and reception function for a plurality of frequencies. Thus, the communication area of each RU is formed at a plurality of frequencies, as indicated by 104-1 to 104-4 and 107-1 to 107-4 in FIGS. 13 to 15. In the second embodiment, as in FIG. 2, RUs in which a number of terminals are distributed near the boundary of the communication areas are detected, and an identical cell ID is allocated to the RUs. However, the control for allocating an identical cell ID is limited to some of the frequency carriers. The frequency carrier that implements cell ID allocation control is denoted as a first frequency, and the other frequency carriers are denoted as a second frequency. In this case, in the communication area of the RU to which an identical cell ID is allocated at the first frequency, the first frequency has a large cell size, and a high quality area is formed also at the boundary of a center area of RU. On the other hand, at the second frequency, while the cell size is small and communication quality is lowered at the RU communication area boundary, there is formed an area in which the wireless capacity increasing effect, i.e., the conventional effect of reducing the size of the cell, is maintained. Namely, the first frequency can provide the role of a conventional macrocell, while the second frequency provides the original role of a small cell. The second embodiment of the present invention aims to enable efficient communication by forming a plurality of frequencies with such different characteristics and selectively using them.

FIG. 13 illustrates an example of the selective use of frequencies depending on the position of the terminal in a case where the terminal can communicate only using a single frequency. The terminal capable of communication only using a single frequency is referred to as a carrier aggregation (CA) incapable terminal. Whether the terminal is adapted to CA is notified from the terminal to the base station (L2/L3 processor). In FIG. 13, at the first frequency, an identical cell ID is allocated to RU 103-1 and RU 103-2. At this time, CU 105 preferentially connects the terminal 106-2 positioned at the boundary of the communication area of RU 103-1 or RU 103-2 to the first frequency. Meanwhile, the terminals 106-1 and 106-3 positioned at the center of the communication areas of RU 103-1 and RU 103-2 are preferentially connected to the second frequency. This can be realized by setting certain offset values to the reception power of the first frequency or the second frequency. For example, an offset value is set such that the terminal is connected to the first frequency when the reception power of the first frequency becomes greater than the value of the reception power of the second frequency to which the offset value is added. The effect of increasing the reception power by using the same cell ID is large at the boundary of the communication area of RU but small at the center of the communication area. Thus, at the boundary of the communication area of RU, the reception power of the first frequency becomes greater than the value of the reception power of the second frequency to which the offset value is added, making connection to the first frequency easier. On the other hand, at the center of the communication area of RU, the reception power of the first frequency becomes smaller than the value of the reception power of the second frequency to which the offset value is added, making connection to the second frequency easier. As a result, the terminals 106-1 to 106-3 can perform communication at the frequency with high communication quality. With regard to RU 103-3 and 103-4 to which an identical cell ID is not allocated, the priority for connection may be the same between the frequencies.

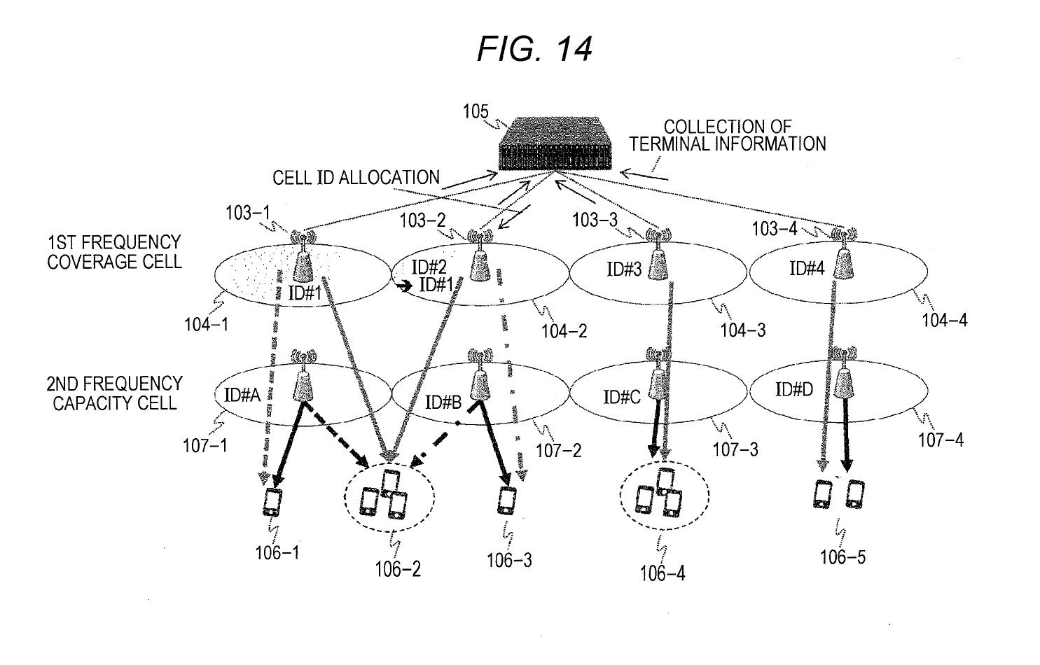

FIG. 14 illustrates an example of the selective use of the frequency depending on the position of the terminal capable of communication using a plurality of frequencies. The terminal capable of communication using a plurality of frequencies is referred to as a CA-capable terminal. The CA-capable terminal can perform communication using the first frequency and the second frequency simultaneously or using only one of the frequencies. At this time, the terminal 106-2 positioned at the boundary of the communication areas of RU 103-1 and RU 103-2 have high communication quality at the first frequency and low communication quality at the second frequency. Meanwhile, the terminals 106-1 and 106-3 positioned at the center of the communication areas of RU 103-1 and RU 103-2 have a small difference in communication quality between the first frequency and the second frequency. Thus, CU 105 preferentially schedules the terminal 106-2 positioned at the boundary of the communication areas of RU 103-1 and RU 103-2 at the first frequency, while preferentially scheduling the terminals 106-1 and 106-3 positioned at the center of the communication area at the second frequency. However, because the terminals 106-1 to 106-3 are capable of communication at both the first frequency and the second frequency, the terminal 106-2 may perform communication using the second frequency, depending on the result of scheduling. In FIG. 14, this corresponds to the signal (dashed line) being transmitted from RU 103-1 (cell ID #A) to the terminal 106-2 and the signal (dot-dash line) being transmitted from RU 103-2 (cell ID #B) to the terminal 106-2. These signals are different signals. The terminals 106-1 and 106-3 may perform communication using the first frequency. In FIG. 14, this corresponds to the signal (dashed line) being transmitted from RU 103-1 to the terminal 106-1 and the signal (dot-dash line) being transmitted from RU 103-2 to the terminal 106-3 at the first frequency. These signals are different signals. With regard to RU 103-3 and 103-4 to which an identical cell ID is not allocated, the scheduling priority may be the same between the frequencies.

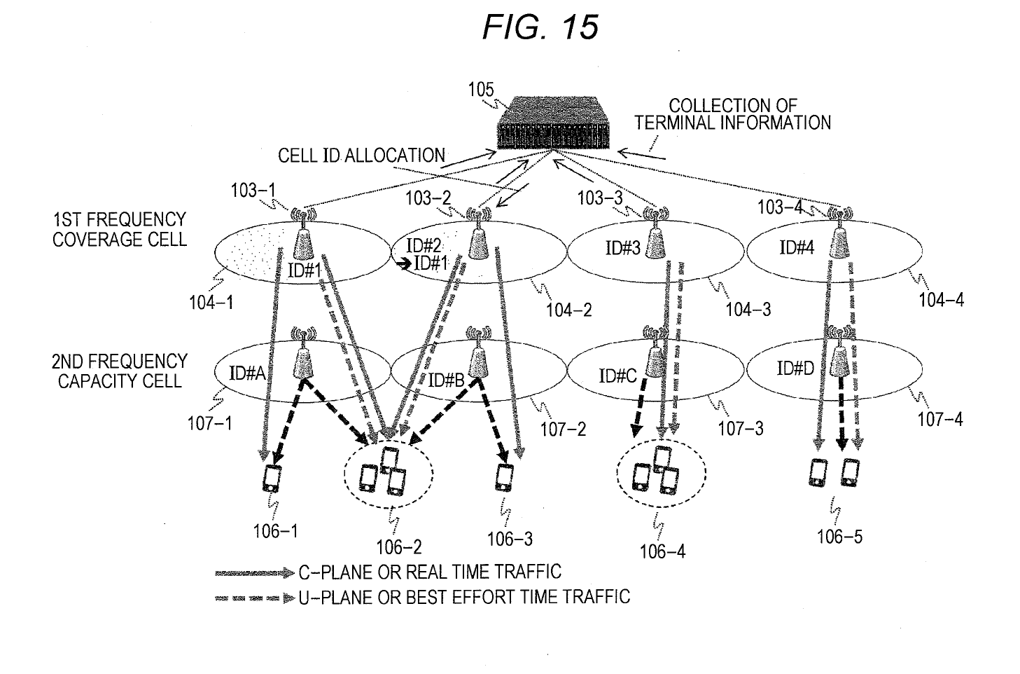

FIG. 15 illustrates an example of the selective use of the frequency depending on the type of traffic and the terminal position. The present operation is directed to the CA-capable terminal. The boundary of the communication areas of RU 103-1 and RU 103-2 is an area in which a number of terminals are distributed and in which the communication quality of the first frequency is increased by the allocation of the same cell ID. Thus, for the C-plane traffic which is a terminal control traffic for which communication stability is important, the first frequency is used for transmission. On the other hand, for the U-plane traffic which is a terminal data traffic for which wireless capacity is important, the second frequency is used for transmission. However, with regard to the terminals positioned at the boundary of the communication areas of RU, because the communication quality at the second frequency is low, the first frequency may also be preferentially used for transmission for the U-plane. Similarly, for real-time traffic for which communication stability and small delay are important, the first frequency is used for transmission. Meanwhile, for best effort traffic for which wireless capacity is important, the second frequency is used for transmission. However, with regard to the terminals positioned at the boundary of the communication areas of RU, the first frequency may be preferentially used for transmission even for the best effort traffic.

According to CA, the frequency at which a terminal establishes connection is referred to as a primary cell (PCell), while the frequency used as an additional wireless resource is referred to as a secondary cell (SCell). Information about terminal security, information between a terminal and a mobility management entity (which may be referred to as Non Access Stratum information or NAS) and the like are exchanged using PCell. While modification of PCell requires a handover, modification of SCell can be performed by modifying the wireless resource setting and does not require a handover. Thus, when CA is implemented, the generation of a handover as a result of the movement between RUs having an identical cell ID can be decreased by operating the first frequency as PCell and the second frequency as SCell. For this purpose, the offset value set for each cell or frequency for cell selection may be set such that the cell at the first frequency is more easily connectable than the cell at the second frequency. Further, in this case, in consideration of the ease of handover and the like, the first frequency may be used for PCell while the second frequency may also be used for SCell in RUs 103-3 and 103-4 to which an identical cell ID is not allocated.

In another method for the selective use of the frequency, the frequency may be selected depending on the speed of movement of the terminal. For example, the terminal with high speed of movement is preferentially connected to the first frequency, and the terminal with low speed of movement is preferentially connected to the second frequency. Alternatively, when CA is implemented, the terminal with high speed of movement is preferentially scheduled at the first frequency while the terminal with low speed of movement is preferentially scheduled at the second frequency. As in the case of transmission mode control according to the first embodiment, the terminal with high speed of movement, even if positioned at the center of the communication area of a certain RU, has a high probability of moving to the boundary of the communication area of the RU or to the center of the communication area of a different RU in a short time. Thus, by preferentially connecting the terminal with high speed of movement to the first frequency, the handover as a result of the movement between the RUs can be avoided. Similarly, by preferentially scheduling the terminal with high speed of movement at the first frequency, the problem of the modification of RU (Namely, modification of SCell) failing to catching up with the movement of the terminal can be avoided.

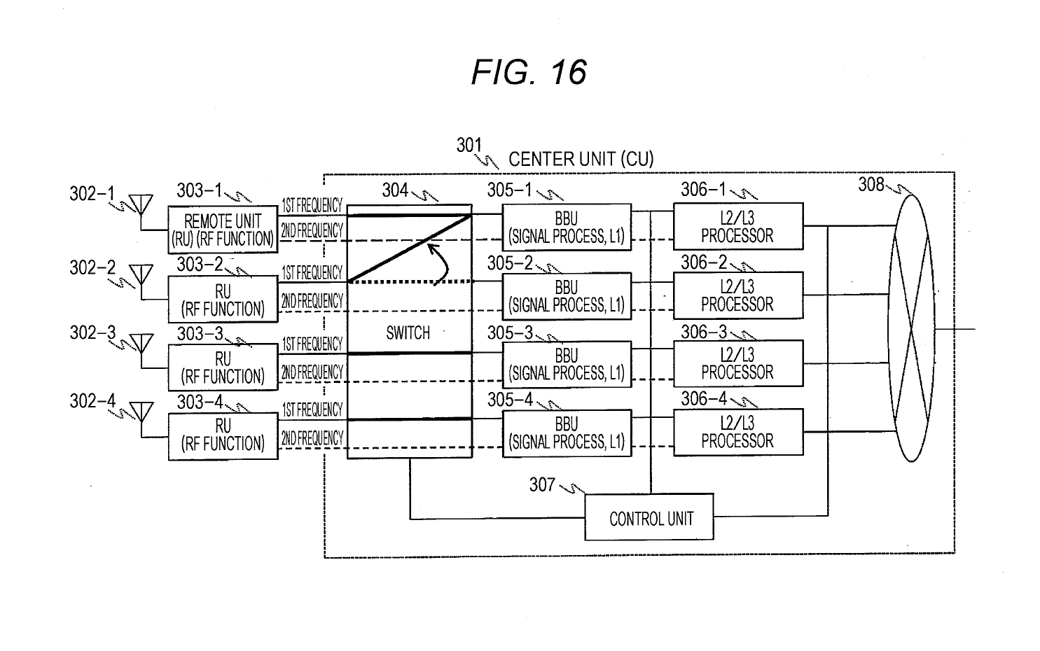

FIG. 16 illustrates an example of the configuration of RU 303 and CU 301 according to the second embodiment where a plurality of frequencies are used. While the basic configuration is similar to FIG. 4, the example differs in that RU 303, BBU 305, and the L2/L3 processor 306 include a multiple frequencies function. The switch 304 connects BBU 305 and RU 303 one-to-one with respect to the second frequency, while connecting BBU 305 and RU 303 one-to-many with respect to the first frequency in accordance with control from the control unit. However, at the first frequency, when an identical cell ID is allocated, the corresponding L2/L3 processors 306 need to operate in a coordinated manner when CA is used. For example, in FIG. 16, coordinated scheduling and the like is performed by sharing the buffer information of the connected terminals, and communication quality information and the like between the L2/L3 processor 306-1 and the L2/L3 processor 306-2.

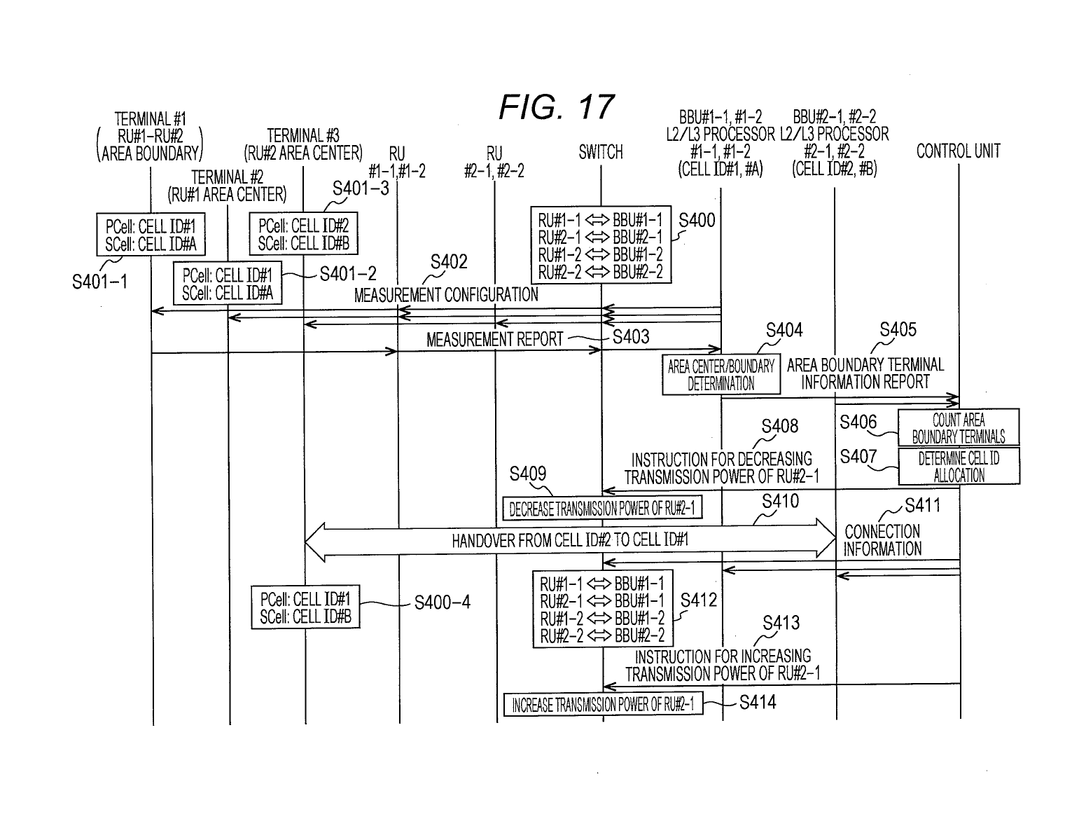

FIG. 17 illustrates an example of the operation sequence up to the allocation of the identical cell ID to a plurality of RUs at the first frequency according to the second embodiment of the present invention. Here, for the sake of description, the functions in RU #1 and RU #2 corresponding to the first frequency and the second frequency are respectively denoted by RU #1-1, RU #1-2 and RU #2-1, RU #2-2. Similarly, the functions in BBU #1 and BBU #2 corresponding to the first frequency and the second frequency are respectively denoted by BBU #1-1, BBU #1-2 and BBU #2-1, BBU #2-2. The functions of L2/L3 processor #1 and L2/L3 processor #2 corresponding to the first frequency and the second frequency are respectively denoted by L2/L3 processor #1-1, L2/L3 processor #1-2 and L2/L3 processor #2-1, L2/L3 processor #2-2. However, when the distinction of the frequency is not required, the notations RU #1 and RU #2, BBU #1 and BBU #2, and L2/L3 processor #1 and L2/L3 processor #2 will be used.

The basic operation of FIG. 17 is similar to FIG. 7. It is assumed that in the initial state, the connection between RU and BBU is such that RU #1-1 and BBU #1-1, RU #2-1 and BBU #2-1, RU #1-2 and BBU #1-2, and RU #2-2 and BBU #2-2 are respectively connected (S400). The positions of the terminals #1 to #3 are the same as in FIG. 7 or 12. However, the terminals #1 to #3 are CA-capable terminals, with the terminal #1 and the terminal #2 implementing CA using cell ID #1 (BBU #1-1, L2/L3 processor #1-1) for PCell, and cell ID #A (BBU #1-2, L2/L3 processor #1-2) (S401-1, S401-2) for SCell. The terminal #3 implements CA using cell ID #2 (BBU #2-1, L2/L3 processor #2-1) for PCell and cell ID #B (BBU #1-2, L2/L3 processor #1-2) for SCell (S401-3). The L2/L3 processors #1 and #2, as in S102 in FIG. 7, perform measurement configuration in each terminal for determining whether the terminal is positioned at the boundary of the communication area of RU (S402). The terminal #1 positioned at the boundary of the communication areas of RU #1 and RU #2 makes a measurement report corresponding to the set measurement configuration (S403). The L2/L3 processor, based on the report from the terminal #1, determines that the terminal #1 is positioned at the boundary of the communication areas of RU #1 and RU #2 (S404). As in the case of FIG. 7, the L2/L3 processors #1 and #2 count, among the connected terminals, the number of the terminals satisfying the condition set in S402, the cell IDs satisfying the condition, and the number of the terminals not satisfying the condition. The number of the terminals herein counted may be distinguished on a frequency by frequency basis; alternatively, a total value for a plurality of frequencies may be calculated. Then, as in S105, the information is combined with the frequency number and reported to the control unit (S405). The control unit, as in S106 of FIG. 7, computes the number of the terminals at the communication area boundary of each RU per unit time, and an average number of terminals at the area boundary (S406). For the number of the terminals at the area boundary, the control unit computes a total value for a plurality of frequencies. Then, as in S107, cell ID allocation determination is performed. It is now assumed that the control unit determines that an identical cell ID should be allocated to RU #1 and RU #2. While the operation from S408 to S414 is similar to S108 to S114, the operation is performed only with respect to the first frequency. As a result, a handover of the terminal #3 occurs from the cell of RU #1-2 (cell ID #2) to the cell of RU #1-1 and 1-2 (cell ID #1). Namely, the cell ID of PCell is modified from cell ID #2 to cell ID #1. However, with respect to the second frequency, the cell ID is not modified, so that the terminal #3 can still utilize the cell of cell ID #B formed by RU #2-2 even after the handover.

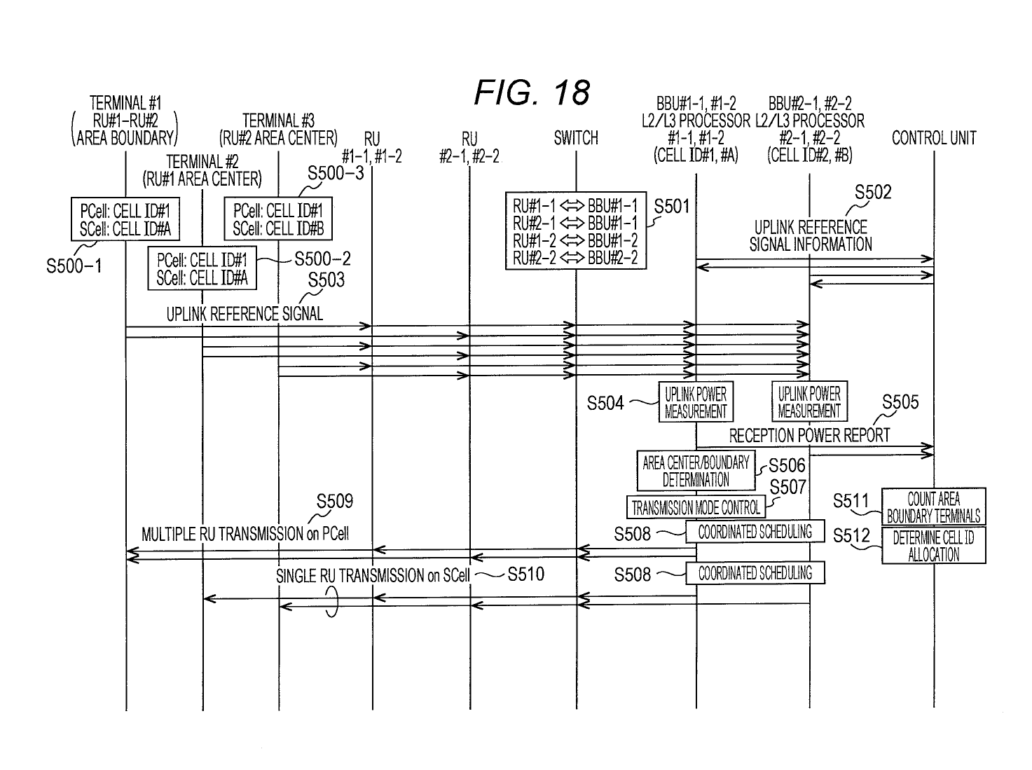

FIG. 18 illustrates an example of the operation sequence according to the second embodiment where a plurality of RUs have the same cell ID. As the basic operation is similar to FIG. 12, only differences will be described. In S502, the L2/L3 processor notifies the control unit of information of the uplink reference signals of all frequencies, and is notified by the control unit of information of the uplink reference signals of all frequencies. Even when the same cell ID is allocated to RU #1 and RU #2 at the first frequency, the cell IDs are different at the second frequency. Thus, there is an RU (RU #2-2) to be connected for BBU #2-2 and L2/L3 processor #2-2. Thus, the control unit also exchanges the information of the uplink reference signals with the L2/L3 processor #2. In S503 and S504, the uplink reference signals are transmitted at both the first frequency and the second frequency, and the respectively corresponding L2/L3 processors measure the uplink reception power. In S505, the measured reception power is notified to the control unit, together with information about the RU number, the terminal ID, the corresponding cell ID, the frequency number and the like. In S506, the L2/L3 processor #1 determines, based on the reception power of each RU at the first frequency, whether each terminal is positioned at the area boundary of RU #1 and RU #2. Alternatively, the information of uplink reception power may be exchanged between the L2/L3 processor #1 and the L2/L3 processor #2, and whether the terminal is at the area boundary may be determined by averaging the reception power of a plurality of frequencies. When the terminal is determined to be at the area boundary at either one of the frequencies, the terminal may be determined to be an area boundary terminal. The transmission mode control in S507 is performed at the first frequency. In S508, in accordance with the various methods for selective use of frequencies described with reference to FIGS. 13 to 15, scheduling is performed in the L2/L3 processors #1 and #2 in a coordinated manner. For example, the terminal #1 positioned at the boundary of the communication areas of RU #1 and RU #2 performs multiple RU transmission at the first frequency (i.e., PCell) (S509). The terminal #2 and the terminal #3 positioned at the center of the communication areas of RU #1 and RU #2 perform transmission each using a single RU at the second frequency (i.e., SCell) (S510).

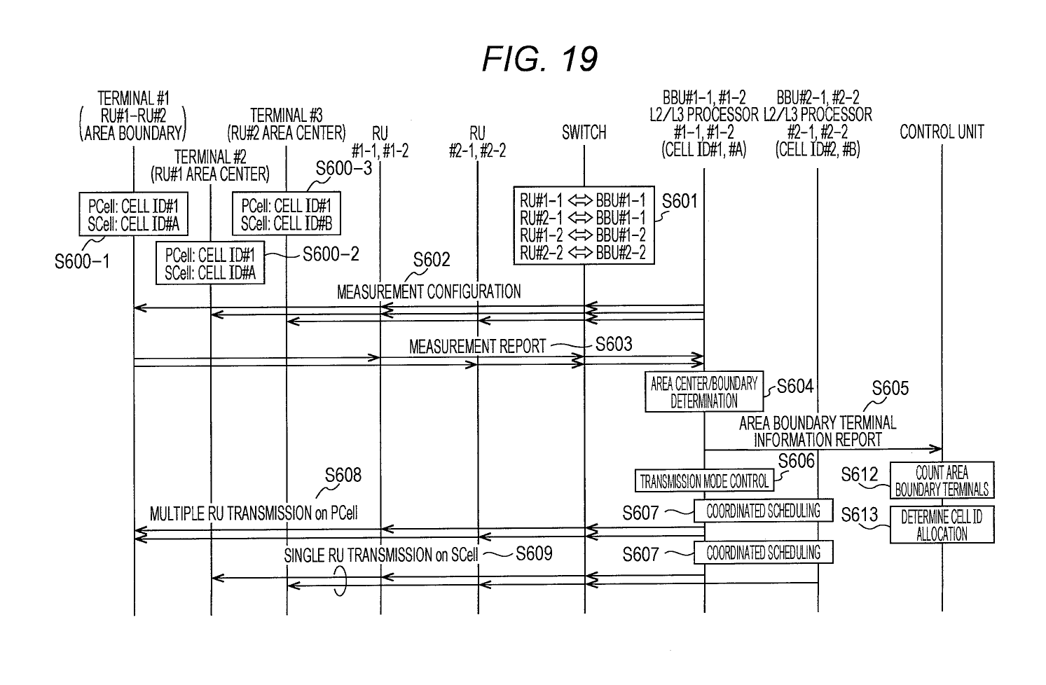

FIG. 19 illustrates another example of the operation sequence of the second embodiment where a plurality of RUs have the same cell ID. The example differs from FIG. 18 in that the RU area boundary determination is performed using the measurement report reported from the terminal. When a plurality of frequencies are used, an identical cell ID is allocated to only some of the frequencies (the first frequency). Thus, at the other frequencies (the second frequency), each RU has a different cell ID. Accordingly, by using the reception power of the downlink reference signal at the frequency, it can be determined whether each terminal is positioned at the boundary or the center of the communication area of each RU.

In S602, a measurement configuration for the measurement and reporting of the reception power of each RU at the second frequency is performed. For the measurement configuration that is set herein, event A6 as defined by LTE may be used. According to event A6, a determination similar to the one for the above-described event A3 is performed for an adjacent cell having the same frequency as SCell and, when a set condition is satisfied, the terminal reports a measurement report (S603). This method may be used when each terminal is using CA. The L2/L3 processor #1 may then determine that the terminal that has reported the measurement report set in S603 is positioned at the boundary of the communication areas of the RU corresponding to SCell and the RU satisfying the condition (S604). Also, the terminal not satisfying the present condition may be determined to be a terminal positioned at the center of the communication area of the RU corresponding to SCell. Meanwhile, the terminal not using or supporting CA may be set to report the reception power of each cell at the second frequency periodically rather than on an event driven basis. Then, in the L2/L3 processor, it is determined whether the condition of event A6 is satisfied. The L2/L3 processor notifies the control unit of the information about the number of the terminals that has been determined by the above method as being at the area boundary, as in S405 of FIG. 17 (S605). The operation from S606 to S609 is similar to S507 to S510. The operations for computing the number of the terminals at the communication area boundary of each RU per unit time and the average number of terminals at the area boundary in S612 are similar to S406 in FIG. 17. For the cell ID allocation determination in S613, a method similar to FIG. 11 may be used.

### 3. Third Embodiment

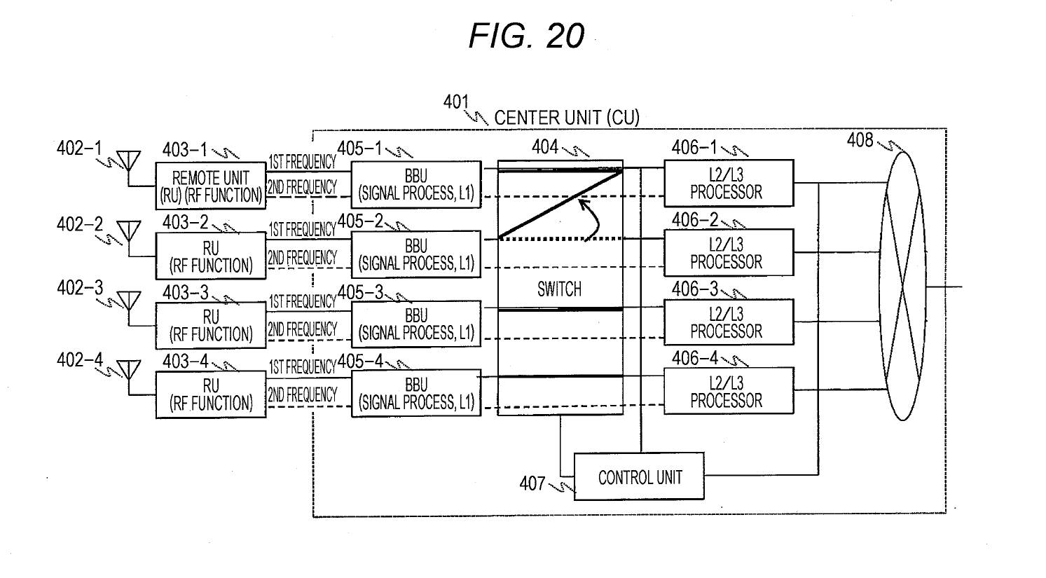

FIG. 20 illustrates an example of the device configuration according to a third embodiment of the present invention. In the third embodiment, a switch 404 is disposed between the L2/L3 processor 406 and BBU 405. While the example of FIG. 20 is based on the use of a plurality of frequencies, a single frequency may be used. Further, in the configuration according to the third embodiment, BBU 405 may be disposed toward RU 403. The functions of an antenna 402, RU 403, and a network I/F 408 are similar to FIG. 16. A L2/L3 processor 406 notifies BBU 405 of information required by BBU 405 to perform a signal process. For example, the information includes the cell ID used by each BBU 405, the type of the physical control channel (PDCCH, PHICH, PCFICH) or the content of its information, data of a terminal for which PDSCH is scheduled, the terminal ID or wireless resource allocation information, a precoding matrix, a modulation system, and a coding system. The information may be in accordance with the Femto Application Platform Interface (FAPI) standard, for example. The L2/L3 processor 406 to which a plurality of BBUs 405 are connected outputs, to each BBU 405, the address of the destination BBU 405 or its number, and information required by the destination BBU 405 to perform a signal process. When the same signal is transmitted from a plurality of RUs 403, the L2/L3 processor 406 notifies BBU 405 of the same information. The information may include the physical control channel such as CRS, PDCCH, PHICH, or PCFICH, cell system information, a broadcast signal, a synchronization signal, data addressed to a terminal at the boundary of the communication area of RU and its scheduling information. When different signals are transmitted from each of the RUs 403, the L2/L3 processor 406 notifies the different BBUs 405 of different information. The information mainly includes data addressed to a terminal positioned at the center of the communication area of each RU 403 and corresponding scheduling information.

The switch 404 transfers the input information to the destination BBU 405 designated by each L2/L3 processor 406. Generally, the transmission rate of the information notified from the L2/L3 processor 406 to BBU 405 is lower than the transmission rate of the base band signal output from BBU 405. Thus, by using the present configuration, the required performance of delay due to the process in the switch 404 can be mitigated.

BBU 405 performs a physical layer signal process based on the information notified from the L2/L3 processor 406 via the switch.

Alternatively, the L2/L3 processor 406 may attach a flag to each information of which BBU 405 is notified, indicating whether there is a plurality of destinations. When there is a plurality of the destinations, the switch 404 reproduces the information and transfers it to a plurality of BBUs 405. When the destination is a single BBU 405, the L2/L3 processor 406 may output the information including the destination BBU 405 number to the switch 404, and the information may be sorted in the switch 404 in accordance with the destination.

In the uplink, each BBU 405 performs demodulation and decode processes, and notifies the L2/L3 processor 406 of the result. The L2/L3 processor 406, based on the uplink reception result from each BBU 405, selectively receives only correctly decoded data, for example.

When the present configuration is used, while the switch process can be simplified for the downlink, the processes for maximum ratio combining or interference cancellation in the uplink may become difficult. Thus, the configuration of FIG. 20 may be adopted for the downlink, while the configuration of FIG. 16 may be adopted for the uplink.

What is claimed is:

1. A base station comprising:
a plurality of radio units that communicate with a terminal; and
a control device connected to the plurality of radio units, wherein
when there is a large number of terminals positioned at a boundary of communication areas of a first radio unit and a second radio unit among the plurality of radio units, the control device makes a first cell ID of the first radio unit and a second cell ID of the second radio unit being identical.

2. The base station according to claim 1, wherein
the control device includes a plurality of base band units that perform a physical layer signal process, a switch connecting the radio units and the base band units, and a control unit,
the control unit notifies the switch of connecting the first radio unit and the second radio unit to an identical base band unit, and
the switch, based on information notified from the control unit, modifies a connection between the first radio unit or the second radio unit and the base band unit.

3. The base station according to claim 2, wherein
the control unit, when modifying the second cell ID to the first cell ID, decreases transmission power of the second radio unit, modifies the connection in the switch between the second radio unit and the base band unit, and increases transmission power of the second radio unit.

4. The base station according to claim 1, wherein
the control device is provided with a plurality of processors that perform an upper layer process,
the processors, when the terminal is positioned at the boundary of the communication areas of the first radio unit and the second radio unit having an identical cell ID, transmit a signal of the terminal using the first radio unit and the second radio unit, and
the processors, when the terminal is positioned at the center of the communication area of the first radio unit or the second radio unit, transmit the signal of the terminal using the first radio unit or the second radio unit.

5. The base station according to claim 1, wherein
the control device is provided with a plurality of processors that perform an upper layer process,
the processors, when a difference in reception power of downlink reference signals between a connecting cell and a cell adjacent to the connected cell is smaller than a predetermined threshold value, set the terminal to transmit the reception power of the connected cell and the adjacent cell, and
the processors, upon reception of the reception power of the connected cell and the adjacent cell from the terminal, determine that the terminal is positioned at the boundary of the communication areas of the radio unit corresponding to the connected cell and the radio unit corresponding to the adjacent cell.

6. The base station according to claim 1, wherein
the control device, when the number of the terminals positioned at the boundary of the communication areas of the first radio unit and the second radio unit having an identical cell ID is decreased, makes the cell ID of the first radio unit and the cell ID of the second radio unit different.

7. The base station according to claim 1, wherein the control device detects that there is the large number of terminals positioned at the boundary of the communication areas based on the number of the terminals positioned at the boundary of the communication areas of the first radio unit and the second radio unit, and/or a ratio of the terminals positioned at the boundary of the communication areas to all of the terminals positioned in the communication areas of the first radio unit and the second radio unit.

8. The base station according to claim 1, wherein the control device detects that there is the large number of terminals positioned at the boundary of the communication areas based on the amount of traffic of the terminals positioned at the boundary of the communication areas of the first radio unit and the second radio unit, and/or a ratio of an amount of traffic of the terminals positioned at the boundary of the communication areas to an amount of traffic of all of the terminals positioned in the communication areas of the first radio unit and the second radio unit.

9. The base station according to claim 1, wherein, when the radio unit uses a plurality of frequencies, the control device makes the first cell ID and the second cell ID being identical at a first frequency of the plurality of frequencies.

10. The base station according to claim 9, wherein
the control device is provided with a plurality of processors that perform an upper layer process,
when the terminal performs communication using a single frequency, and when the terminal is positioned at the boundary of the communication areas of the first radio unit and the second radio unit having an identical cell ID, the processors preferentially connect the terminal to the first frequency, and
when the terminal is positioned at the center of the communication area of the first radio unit or the second radio unit having an identical cell ID, the processors preferentially connect the terminal to a second frequency different from the first frequency.

11. The base station according to claim 9, wherein
the control device is provided with a plurality of processors that perform an upper layer process,
when the terminal performs communication using a plurality of frequencies, and when the terminal is positioned at the boundary of the communication areas of the first radio unit and the second radio unit having an identical cell ID, the processors make the terminal perform communication using the first frequency preferentially, and
when the terminal is positioned at the center of the communication area of the first radio unit or the second radio unit having an identical cell ID, the processors make the terminal perform communication preferentially using a second frequency different from the first frequency.

12. The base station according to claim 9, wherein
the control device is provided with a plurality of processors that perform an upper layer process,
when the terminal uses a plurality of frequencies for communication, the processors transmit a traffic for controlling the terminal preferentially using the first frequency, and transmit a traffic for data of the terminal preferentially using a second frequency different from the first frequency.

13. The base station according to claim 9, wherein
the control device is provided with a plurality of processors that perform an upper layer process,
when the terminal uses a plurality of frequencies for communication, the processors transmit a real-time traffic of the terminal preferentially using the first frequency, and transmit a best effort traffic of the terminal preferentially using a second frequency different from the first frequency.

14. A wireless communication system comprising:
a plurality of terminals; and
a base station including a plurality of radio units that communicate with the terminal, and a control device connected to the plurality of radio units,
wherein
when there is a large number of terminals positioned at the boundary of communication areas of a first radio unit and a second radio unit of the plurality of radio units, the control device makes a first cell ID of the first radio unit and a second cell ID of the second radio unit being identical, and
when the radio units use a plurality of frequencies, the control device makes the first cell ID and the second cell ID being identical at a first frequency of the plurality of frequencies.

15. A wireless communication method for a wireless communication system including a plurality of terminals, and a base station including a plurality of radio units that communicate with the terminals,
wherein
when there is a large number of terminals positioned at the boundary of communication areas of a first radio unit and a second radio unit of the plurality of radio units, the base station makes a first cell ID of the first radio unit and a second cell ID of the second radio unit being identical, and
when the radio units use a plurality of frequencies, the base station makes the first cell ID and the second cell ID being identical at a first frequency of the plurality of frequencies.
